(19) United States
(12) Patent Application Publication
(10) Pub. No.: US 2004/0203697 A1
(43) Pub. Date: Oct. 14, 2004

(54) Ultra wideband remote control system and method

(76) Inventor: James Finn, Baltimore, MD (US)

Correspondence Address: TIME DOMAIN CORPORATION, 7057 OLD MADISON PIKE, HUNTSVILLE, AL, 35806, US

(21) Appl. No.: 10/225,298

(22) Filed: Aug. 22, 2002

(51) Int. Cl. H04B 5/00; H04M 3/00; H04M 1/00; H04B 1/38

(52) U.S. Cl. 455/420; 455/563; 455/41.2

(57) ABSTRACT

The present invention relates to an ultra wideband wireless, voice-activated remote control device for controlling an electronic device having voice control circuitry. A short-range ultra wideband wireless data and voice communication link is established between the remote control device and the electronic device. To activate voice control circuitry in the electronic device, a user supplies an input to the remote control device. In response to the user input, ultra wideband wireless link circuitry within the remote control device sends a control signal via ultra wideband techniques, for example an AT command transmitted through the ether using ultra wideband technology, to the electronic device. The electronic device receives the control signal and transmits a control signal indicating the status of the electronic device. Once the voice control circuitry is activated, the user provides a voice command to the remote control device. The remote control device transmits the voice signal to the electronic device over the wireless communication link. The electronic device processes the voice signal in the voice control circuitry and generates instructions in response to the voice signal if recognized. The voice control circuitry is advantageously located within the electronic device and not within the remote control device to simplify the remote control device and to minimize the amount of power dissipated in the remote control device.

### BACKGROUND OF THE INVENTION

1. Field of the Invention

This present invention relates to wireless remote controls. More particularly the present invention relates to voice activated wireless remote control. Still more particularly the present invention relates to voice activated wireless remote control of electronic devices. Yet more particularly, to a system and method of voice activated wireless remote control of electronic devices using ultra wideband wireless for significant system improvements.

2. Background of the Invention and Related Art

The control of electronic devices has traditionally required the manual operation of dials, buttons, keyboards, keypads and the like. This can be an impractical, awkward or undesirable requirement for several reasons. For example, a person who is working, driving, or performing some other task requiring the use of his hands, may simultaneously attempt to use a communication device to call another person. This can be difficult at best, and dangerous at worst.

Additionally, as technology progresses, manufacturers of electronic devices are continually reducing the size of the devices, and thus also reducing the size of the keyboards, keypads or other mechanical interfaces. This reduction in size makes it difficult for users to easily input accurate information.

Even when a full size interface is available and no other activity is being performed, a manually operated interface can be problematic. For example, computer users are frequently required to perform repetitive hand motions that can lead to serious physical injury over time.

Voice recognition technology has been developed for use in electronic devices in response to these problems. In general, conventional voice recognition technology comprises a mechanism for receiving an input voice signal, comparing the input voice signal with stored voice signals, and determining if the input voice signal is sufficiently similar to any of the stored voice signals. If the determining step reveals a match, instructions or other data associated with the similar stored voice signal, such as a telephone number or device command, is generated by the device. However, conventional voice recognition technology has required that a user be sufficiently proximate to the electronic device to ensure that the voice signal is adequately received. In addition, conventional voice recognition technology requires that the user depress a button on the electronic device to activate the technology.

User headsets or other remote control devices have also been developed to permit a user to have his hands free to perform other tasks while communicating with an electronic device. Such headsets do permit the user to have some distance away from the device. However, such devices are tethered to the device via a wire or a wireless radio link requiring the user to sustain relatively close proximity to the device. In application, such headsets typically must be used within one meter or so of the electronic device.

Those conventional headsets and other remote control devices provide marginal improvement at best because situations often arise in which a user desires to utilize an electronic device when the user is not sufficiently close to the device and/or the user is not able to utilize the small mechanical interface. For example, with respect to a communication device such as a telephone, a person may desire to receive an incoming call when the telephone starts ringing even though the telephone is some distance away. Alternatively, a person may desire to place a call on a small device, such as a cellular telephone, without having to input information using the small keypad associated with the device.

This problem was initially addressed as described in U.S. Pat. No. 6,339,706 entitled, “Wireless voice activated control device” issued Jan. 15, 2002, to Tillgren et al. However, in this patent conventional wireless transfer of data was employed. For example, the control information was accomplished via traditional RF means. One of the primary wireless information transfer means is through a bluetooth wireless standard. Bluetooth radios operate in an unlicensed Instrumentation, Scientific, Medical (ISM) band at 2.4 GHz. A frequency hop transceiver may be applied to combat interference and fading. A shaped, binary FM modulation is applied to minimize transceiver complexity. The gross data rate is 1 Mb/s and a time-division duplex scheme is used for full-duplex transmission.

The Bluetooth baseband protocol is a combination of circuit and packet switching. Slots can be reserved for synchronous packets. Each packet is transmitted in a different hop frequency. A packet nominally covers a single slot, but can be extended to cover up to five slots. Bluetooth can support an asynchronous data channel, up to three simultaneous synchronous voice channels, or a channel which simultaneously supports asynchronous data and synchronous voice. Each voice channel supports 64 kb/s synchronous (voice) link. The asynchronous channel can support a symmetric link of maximally 721 kb/s in either direction while permitting 57.6 kb/s in the return direction, or a 432.6 kb/s symmetric link.

The Bluetooth air interface is based on a nominal antenna power of 0 dBm. Spectrum spreading has been added to facilitate optional operation at power levels up to 100 mW worldwide. Spectrum spreading is accomplished by frequency hopping in 79 hops displaced by 1 MHz, starting at 2.402 GHz and stopping at 2.480 GHz. Due to local regulations the bandwidth is reduced in Japan, France and Spain. This is handled by an internal software switch. The maximum frequency hopping rate is 1600 hops/s. The nominal link range is 10 centimeters to 10 meters, but can be extended to more than 100 meters by increasing the transmit power.

Notwithstanding the above attributes of Bluetooth, there are a number of shortcomings. Bluetooth-enabled devices don't provide the level of security that is required. And the range of 100 feet gets seriously compromised when walls go up between devices. The standard speed for wireless Ethernet connections is now approaching 10 Mbps and because, as mentioned, Bluetooth's top speed is about 720 Kbps seamless connectivity cannot be established. Further, although Bluetooth supporters say they don't compete with another wireless technology, HomeRF, or other 802.11B standards vying for wireless networking dominance, FCC rules allowing HomeRF to operate at a faster speed could cause interference with Bluetooth devices. Regarding channel capacity, it has been demonstrated that as few as seven Bluetooth enabled devices can operate in a given area, which clearly is insufficient if for a large number of portable computers to simultaneously operate in a give area.

Infra Red has also been a wireless transfer possibility utilized with the present invention; however, when any barrier to transfer is present (e.g., a wall or other obstacle) the connection can be lost. Also, anything affecting the line of sight such as haze, smoke or other obstruction can cause a lost connection.

Thus, there exists a need for a wireless voice-activated remote control device that enables a user to activate an electronic device using voice control technology without having to maintain a small distance between the remote control device and the electronic device and which overcomes the shortcomings of existing wireless techniques, such as Bluetooth. There is no current technology that integrates voice recognition technology and an improved wireless technique to control an electronic device at a relatively large distance and/or in a high multipath environment and thus avoids the shortcomings of existing wireless technologies and enables inherent distance determination.

### SUMMARY OF THE INVENTION

Accordingly, the present invention overcomes these and other problems associated with current technology by providing an ultra wideband wireless, voice-activated remote control system for controlling an electronic device. The system comprises an electronic device, a remote control device, and an ultra wideband wireless communication link. The electronic device comprises a microphone, a speaker, an ultra wideband antenna, ultra wideband wireless link circuitry, and voice control circuitry. The remote control device comprises a microphone, a speaker, an ultra wideband antenna, ultra wideband wireless link circuitry, and a user input device. The ultra wideband wireless communication link exists between the electronic device and the remote control device to facilitate the transmission of data signals and voice signals. At least one voice signal is input into the microphone of the remote control device. The voice signal is transmitted from the remote control device to the electronic device via the ultra wideband wireless communication link. Upon receipt of the voice signal at the electronic device, the voice control circuitry generates an instruction responsive to the voice signal and the instruction is executed in the electronic device.

In an alternative embodiment, the present invention provides a method of controlling an electronic device with a remote control device. The method comprises establishing an ultra wideband wireless communication link between the electronic device and the remote control device over which data signals and voice signals may be transmitted. The method further comprises receiving a voice signal at the remote control device and transmitting the voice signal from the remote control device to the electronic device via the ultra wideband wireless communication link. The method still further comprises receiving the voice signal at the electronic device, generating an instruction responsive to the voice signal in the electronic device, and executing the instruction in the electronic device.

### BRIEF DESCRIPTION OF THE DRAWINGS

The present invention is described with reference to the accompanying drawings. In the drawings, like reference numbers indicate identical or functionally similar elements. Additionally, the left-most digit(s) of a reference number identifies the drawing in which the reference number first appears.

FIG. 1A illustrates a representative Gaussian Monocycle waveform in the time domain;

FIG. 1B illustrates the frequency domain amplitude of the Gaussian Monocycle of FIG. 1A;

FIG. 1C represents the second derivative of a Gaussian pulse;

FIG. 1D represents the third derivative of the Gaussian pulse;

FIG. 1E represents the Correlator Output vs. the Relative Delay of a measured pulse signal;

FIG. 1F depicts the frequency domain amplitude of the Gaussian family of the Gaussian Pulse and the first, second, and third derivative.

FIG. 2A illustrates a pulse train comprising pulses as in FIG. 1A;

FIG. 2B illustrates the frequency domain amplitude of the waveform of FIG. 2A;

FIG. 2C illustrates the pulse train spectrum;

FIG. 2D is a plot of the Frequency vs. Energy;

FIG. 3 illustrates the cross-correlation of two codes graphically as Coincidences vs. Time Offset;

FIGS. 4A-4E illustrate five modulation techniques to include: Early-Late Modulation; One of Many Modulation; Flip Modulation; Quad Flip Modulation; and Vector Modulation;

FIG. 5A illustrates representative signals of an interfering signal, a coded received pulse train and a coded reference pulse train;

FIG. 5B depicts a typical geometrical configuration giving rise to multipath received signals;

FIG. 5C illustrates exemplary multipath signals in the time domain;

FIGS. 5D-5F illustrate a signal plot of various multipath environments.

FIG. 5G illustrates the Rayleigh fading curve associated with non-impulse radio transmissions in a multipath environment.

FIG. 5H illustrates a plurality of multipaths with a plurality of reflectors from a transmitter to a receiver.

FIG. 5I graphically represents signal strength as volts vs. time in a direct path and multipath environment.

FIG. 6 illustrates a representative impulse radio transmitter functional diagram;

FIG. 7 illustrates a representative impulse radio receiver functional diagram;

FIG. 8A illustrates a representative received pulse signal at the input to the correlator;

FIG. 8B illustrates a sequence of representative impulse signals in the correlation process;

FIG. 8C illustrates the output of the correlator for each of the time offsets of FIG. 8B.

FIG. 9 shows a block diagram of a remote control device and a mobile telephone according to an embodiment of the present invention;

FIG. 10 shows a block diagram of a remote control device and a mobile telephone according to an alternative embodiment of the present invention and with the Ultra Wideband wireless link circuitry included therein;

FIG. 11 shows a state diagram of a state machine according to an embodiment of the present invention;

FIG. 12 shows a state diagram of a state machine according to an alternative embodiment of the present invention;

FIG. 13 shows a flow chart describing an outgoing call being placed from a remote control device according to an alternative embodiment of the present invention; and

FIG. 14 shows a flow chart describing an incoming call being sent to a remote control device according to an alternative embodiment of the present invention.

### DETAILED DESCRIPTION OF THE EMBODIMENTS

Overview of the Invention

The present invention will now be described more fully in detail with reference to the accompanying drawings, in which the preferred embodiments of the invention are shown. This invention should not, however, be construed as limited to the embodiments set forth herein; rather, they are provided so that this disclosure will be thorough and complete and will fully convey the scope of the invention to those skilled in art. Like numbers refer to like elements throughout.

To facilitate an understanding of the invention, many aspects of the invention are described in terms of sequences of actions to be performed by elements of a computer system. It will be recognized that in each of the embodiments, the various actions could be performed by specialized circuits, by program instructions being executed by one or more processors, or by a combination of both. Moreover, the invention can additionally be considered to be embodied entirely within any form of computer readable storage medium having stored therein an appropriate set of computer instructions that would cause a processor to carry out the techniques described herein. Thus, the various aspects of the invention may be embodied in many different forms, and all such forms are contemplated to be within the scope of the invention. For each of the various aspects of the invention, any such form of embodiment may be referred to herein as “logic configured to” perform a described action.

In general, the invention relates to an ultra wideband wireless, voice-activated remote control system including a remote control device, an electronic device to be controlled and an ultra wideband wireless communication link. The remote control device receives the sound of a voice. The voice may be any suitable audio signal, whether it is generated by a living being or by a machine. The remote control device converts this sound into a voice signal, and transmits the voice signal to the electronic device over the ultra wideband wireless communication link. The electronic device receives the voice signal and processes the voice signal with voice control circuitry. The electronic device then generates instructions associated with the voice signal. In one embodiment of the invention, the voice control circuitry is located within the electronic device and not in the remote control device. This simplifies the remote control device, allowing the remote control device to be small and lightweight. In addition, this arrangement permits the remote control device to dissipate only a minimal amount of power.

The present invention can be implemented in a variety of different home and industrial applications. Exemplary electronic devices to be controlled include, but are not limited to, computers, televisions, telephones, stereos, garage door openers, vacuum cleaners, home appliances, business equipment, robots, assembly lines and associated machinery, and motor vehicles. For exemplary purposes, the present invention is described in connection with the control of a mobile telephone.

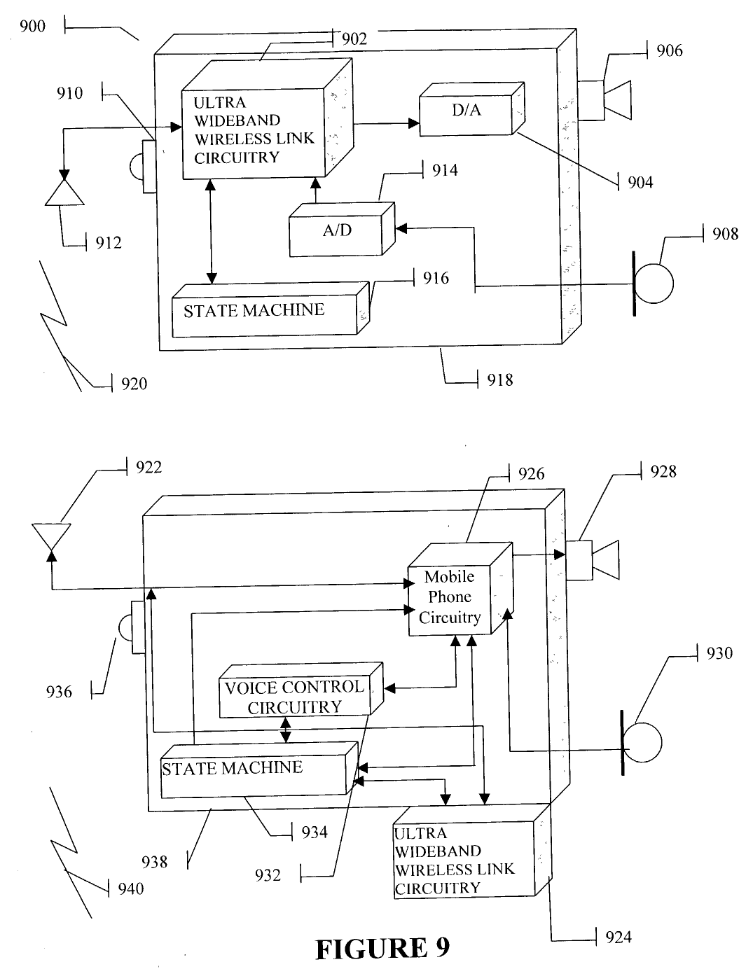

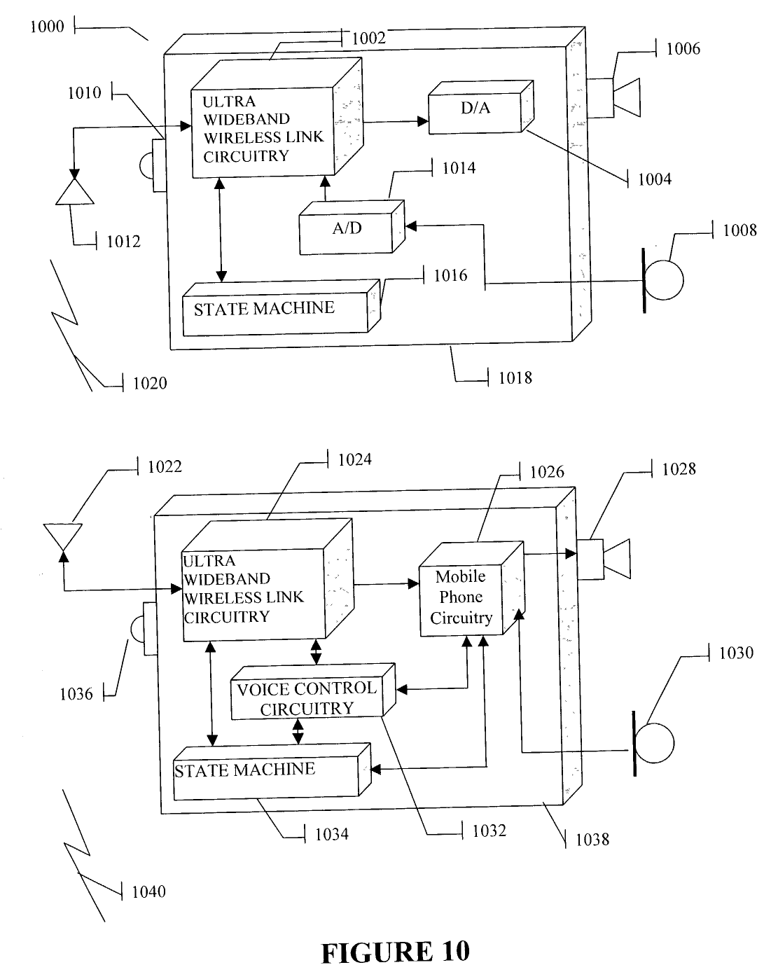

FIG. 9 shows a block diagram of a ultra wideband wireless, voice-activated remote control system 900 including a remote control device 918, such as a headset or wrist device, and an electronic device, exemplified here by a mobile telephone 938, according to one embodiment of the present invention. Remote control device 918 includes an input device or button 910 (which enables a user to manually activate a switch, not shown), a microphone 908, a speaker 906 and an antenna 912. Remote control device 918 also includes a state machine 916, an analog-to-digital (A/D) converter 914, and ultra wideband wireless link circuitry 902. Remote control device 918 may also include other clips, buttons, VELCRO, bands, straps, pads or the like (not shown) to facilitate attachment to a user.

Mobile telephone 938 could be any type of cellular telephone, now known or later developed, using any type of transmission technique for communication with other communication devices such as satellites, base stations, plain old telephones, or other mobile phones over an ultra wideband wireless communication link 940. Mobile telephone 938 includes a microphone 122, a speaker 928 and an Antenna 922. Mobile telephone 938 also includes a mobile telephone circuitry 926, a state machine 934, and voice control circuitry 932. The mobile telephone circuitry 926 performs all functions necessary to enable the mobile telephone 938 to establish and utilize the ultra wideband wireless communication link 940. For example, the mobile telephone circuitry 926 may be particularly adapted to work in accordance with Global System for Mobile communications (GSM) standards, which are well known. Of course, the use of GSM is merely exemplary, and is not essential to the invention; in alternative embodiments the mobile telephone circuitry 926 may operate in accordance with any other mobile communications standards.

In addition to the above mentioned components, mobile telephone 938 includes ultra wideband wireless link circuitry 924. The purpose of the ultra wideband wireless link circuitry 924 is to establish a second wireless link, independent of the ultra wideband wireless communication link 940. The purpose of this second wireless link will be further described below. Ultra wideband wireless link circuitry 924 can be connected to mobile telephone 938 through a plug connection as shown in FIG. 9. Alternatively, ultra wideband wireless link circuitry 1024 can be included within mobile telephone 1038, as shown in FIG. 10.

Referring back to FIG. 9, remote control device 918 communicates with mobile telephone 938 via an ultra wideband wireless communication link 920, which is the second wireless link referred to above. The wireless communication link used herein uses an ultra wideband wireless communication link 920.

Ultra Wideband Technology Overview

Ultra Wideband is an emerging RF technology with significant benefits in communications, radar, positioning and sensing applications. Earlier this year (2002), the Federal Communications Commission (FCC) recognized these potential benefits to the consumer and issued the first rulemaking enabling the commercial sale and use of products based on Ultra Wideband technology in the United States of America. The FCC adopted a definition of Ultra Wideband to be a signal that occupies a fractional bandwidth of at least 0.25, or 1.5 4 GHz bandwidth at any center frequency. The 0.25 fractional bandwidth is more precisely defined as:

$$FBW = \frac{2 ( {f}_{h} - {f}_{l} )}{{f}_{h} + {f}_{l}} ,$$

where FBW is the fractional bandwidth, fₕ is the upper band edge and fₗ is the lower band edge, the band edges being defined as the 10 dB down point in spectral density.

There are many approaches to UWB including impulse radio, direct sequence CDMA, ultra wideband noise radio, direct modulation of ultra high-speed data, and other methods. The present invention has its origin in ultra wideband impulse radio and will have significant application there as well, but it has potential benefit and application beyond impulse radio to other forms of ultra wideband and beyond ultra wideband to conventional radio systems as well. Nonetheless, it is useful to describe the invention in relation to impulse radio to understand the basics and then expand the description to the extensions of the technology.

The following is an overview of impulse radio as an aid in understanding the benefits of the present invention.

Impulse radio has been described in a series of patents, including U.S. Pat. No. 4,641,317 (issued Feb. 3, 1987), U.S. Pat. No. 4,813,057 (issued Mar. 14, 1989), U.S. Pat. No. 4,979,186 (issued Dec. 18, 1990), and U.S. Pat. No. 5,363,108 (issued Nov. 8, 1994) to Larry W. Fullerton. A second generation of impulse radio patents includes U.S. Pat. No. 5,677,927 (issued Oct. 14, 1997), U.S. Pat. No. 5,687,169 (issued Nov. 11, 1997), U.S. Pat. No. 5,764,696 (issued Jun. 9, 1998), U.S. Pat. No. 5,832,035 (issued Nov. 3, 1998), and U.S. Pat. No. 5,969,663 (issued Oct. 19, 1999) to Fullerton et al, and U.S. Pat. No. 5,812,081 (issued Sep. 22, 1998), and U.S. Pat. No. 5,952,956 (issued Sep. 14, 1999) to Fullerton, which are incorporated herein by reference.

Uses of impulse radio systems are described in U.S. Pat. No. 6,177,903 (issued Jan. 23, 2001) titled “System and Method for Intrusion Detection using a Time Domain Radar Array”, and U.S. Pat. No. 6,218,979 (issued Apr. 17, 2001) titled “Wide Area Time Domain Radar Array”, both of which are assigned to the assignee of the present invention, and are incorporated herein by reference.

This section provides an overview of impulse radio technology and relevant aspects of communications theory. It is provided to assist the reader with understanding the present invention and should not be used to limit the scope of the present invention. It should be understood that the terminology ‘impulse radio’ is used primarily for historical convenience and that the terminology can be generally interchanged with the terminology ‘impulse communications system, ultra-wideband system, or ultra-wideband communication systems’. Furthermore, it should be understood that the described impulse radio technology is generally applicable to various other impulse system applications including but not limited to impulse radar systems and impulse positioning systems. Accordingly, the terminology ‘impulse radio’ can be generally interchanged with the terminology ‘impulse transmission system and impulse reception system.’

Impulse radio refers to a radio system based on short, wide bandwidth pulses. An ideal impulse radio waveform is a short Gaussian monocycle. As the name suggests, this waveform attempts to approach one cycle of radio frequency (RF) energy at a desired center frequency. Due to implementation and other spectral limitations, this waveform may be altered significantly in practice for a given application. Many waveforms having very broad, or wide, spectral bandwidth approximate a Gaussian shape to a useful degree.

Impulse radio can use many types of modulation, including amplitude modulation, phase modulation, frequency modulation (including frequency shape and wave shape modulation), time-shift modulation (also referred to as pulse-position modulation or pulse-interval modulation) and M-ary versions of these. In this document, the time-shift modulation method is often used as an illustrative example. However, someone skilled in the art will recognize that alternative modulation approaches may, in some instances, be used instead of or in combination with the time-shift modulation approach.

In impulse radio communications, inter-pulse spacing may be held constant or may be varied on a pulse-by-pulse basis by information, a code, or both. Generally, conventional spread spectrum systems employ codes to spread the normally narrow band information signal over a relatively wide band of frequencies. A conventional spread spectrum receiver correlates these signals to retrieve the original information signal. In impulse radio communications, codes are not typically used for energy spreading because the monocycle pulses themselves have an inherently wide bandwidth. Codes are more commonly used for channelization, energy smoothing in the frequency domain, resistance to interference, and reducing the interference potential to nearby receivers. Such codes are commonly referred to as time-hopping codes or pseudo-noise (PN) codes since their use typically causes inter-pulse spacing to have a seemingly random nature. PN codes may be generated by techniques other than pseudorandom code generation. Additionally, pulse trains having constant, or uniform, pulse spacing are commonly referred to as uncoded pulse trains. A pulse train with uniform pulse spacing, however, may be described by a code that specifies non-temporal, i.e., non-time related, pulse characteristics.

In impulse radio communications utilizing time-shift modulation, information comprising one or more bits of data typically time-position modulates a sequence of pulses. This yields a modulated, coded timing signal that comprises a train of pulses from which a typical impulse radio receiver employing the same code may demodulate and, if necessary, coherently integrate pulses to recover the transmitted information.

The impulse radio receiver is typically a direct conversion receiver with a cross correlator front-end that coherently converts an electromagnetic pulse train of monocycle pulses to a baseband signal in a single stage. The baseband signal is the basic information signal for the impulse radio communications system. A subcarrier may also be included with the baseband signal to reduce the effects of amplifier drift and low frequency noise. Typically, the subcarrier alternately reverses modulation according to a known pattern at a rate faster than the data rate. This same pattern is used to reverse the process and restore the original data pattern just before detection. This method permits alternating current (AC) coupling of stages, or equivalent signal processing, to eliminate direct current (DC) drift and errors from the detection process. This method is described in more detail in U.S. Pat. No. 5,677,927 to Fullerton et al.

Waveforms

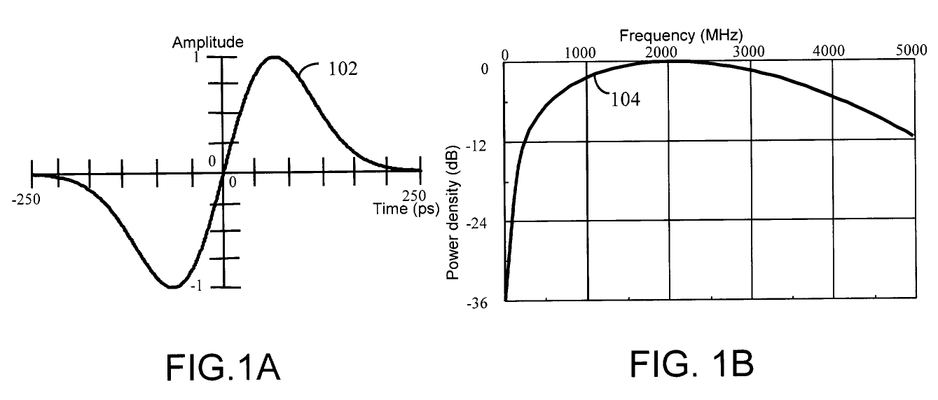

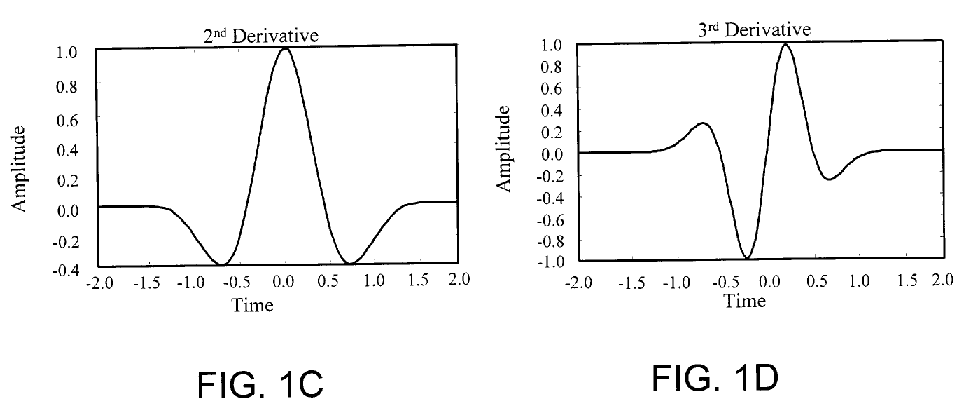

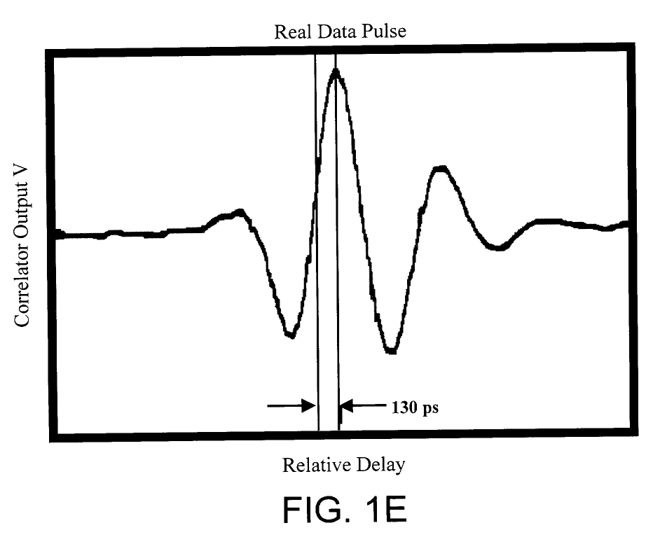

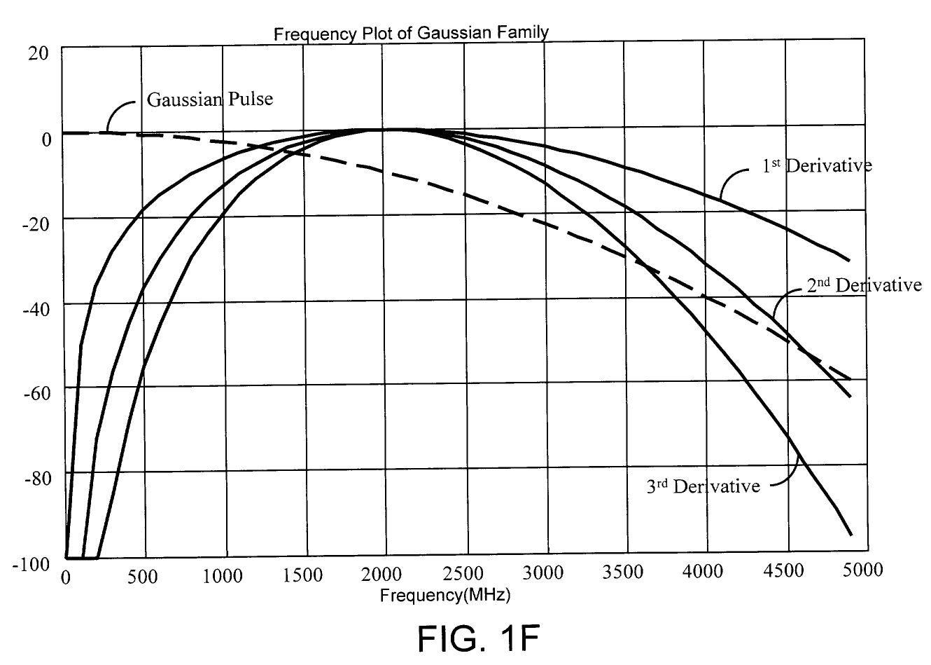

Impulse transmission systems are based on short, wide band pulses. Different pulse waveforms, or pulse types, may be employed to accommodate requirements of various applications. Typical ideal pulse types used in analysis include a Gaussian pulse doublet (also referred to as a Gaussian monocycle), pulse triplet, and pulse quadlet as depicted in FIGS. 1A through 1D. An actual received waveform that closely resembles the theoretical pulse quadlet is shown in FIG. 1E. A pulse type may also be a wavelet set produced by combining two or more pulse waveforms (e.g., a doublet/triplet wavelet set), or families of orthogonal wavelets. Additional pulse designs include chirped pulses and pulses with multiple zero crossings, or bursts of cycles. These different pulse types may be produced by methods described in the patent documents referenced above or by other methods understood by one skilled in the art.

For analysis purposes, it is convenient to model pulse waveforms in an ideal manner. For example, the transmitted waveform produced by supplying a step function into an ultra-wideband antenna may be modeled as a Gaussian monocycle. A Gaussian monocycle (normalized to a peak value of 1) may be described by:

$${f}_{mono} ( t ) = \sqrt{e} ( \frac{t}{σ} ) {ⅇ}^{\frac{- {t}^{2}}{2 {σ}^{2}}}$$

where σ is a time scaling parameter, t is time, and e is the natural logarithm base.

FIG. 1F shows the power spectral density of the Gaussian pulse, doublet, triplet, and quadlet normalized to a peak density of 1. The normalized doublet (monocycle) is as follows:

$${F}_{mono} ( f ) = j ( 2 π ) \sqrt{e} σ f {ⅇ}^{- 2 {( π σ f )}^{2}}$$

Where Fₘₒₙₒ( ) is the Fourier transform of fₘₒₙₒ( ), f is frequency, and j is the imaginary unit. The center frequency (f_{c} ), or frequency of peak spectral density, of the Gaussian monocycle is:

$${f}_{c} = \frac{1}{2 π σ}$$

Pulse Trains

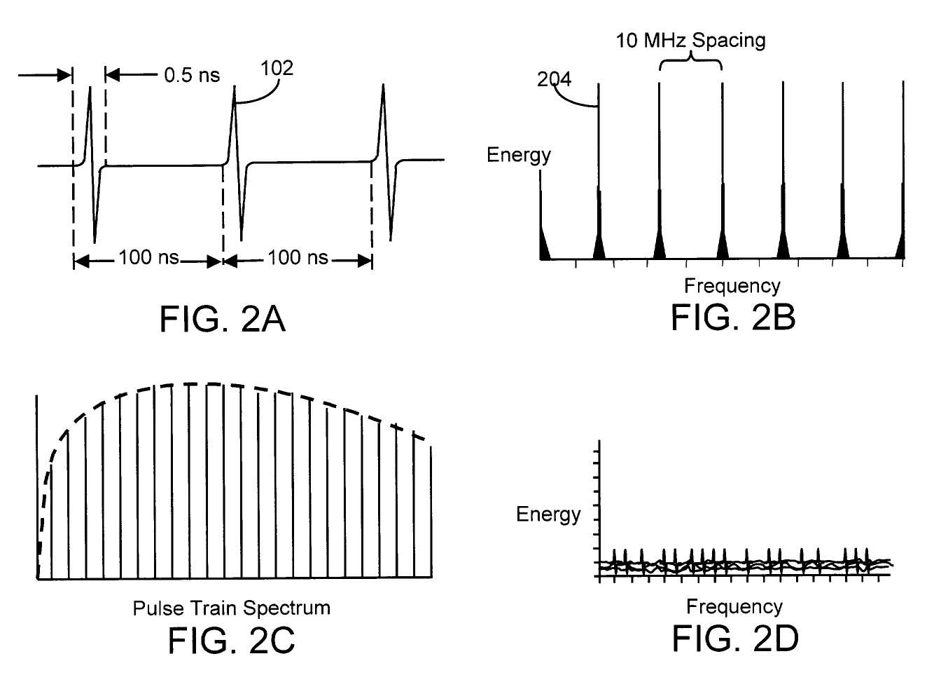

Impulse transmission systems may communicate one or more data bits with a single pulse; however, typically each data bit is communicated using a sequence of pulses, known as a pulse train. As described in detail in the following example system, the impulse radio transmitter produces and outputs a train of pulses for each bit of information. FIGS. 2A and 2B are illustrations of the output of a typical 10 megapulses per second (Mpps) system with uncoded, unmodulated pulses, each having a width of 0.5 nanoseconds (ns). FIG. 2A shows a time domain representation of the pulse train output. FIG. 2B illustrates that the result of the pulse train in the frequency domain is to produce a spectrum comprising a set of comb lines spaced at the frequency of the 10 Mpps pulse repetition rate. When the full spectrum is shown, as in FIG. 2C, the envelope of the comb line spectrum corresponds to the curve of the single Gaussian monocycle spectrum in FIG. 1F. For this simple uncoded case, the power of the pulse train is spread among roughly two hundred comb lines. Each comb line thus has a small fraction of the total power and presents much less of an interference problem to a receiver sharing the band. It can also be observed from FIG. 2A that impulse transmission systems may have very low average duty cycles, resulting in average power lower than peak power. The duty cycle of the signal in FIG. 2A is 0.5%, based on a 0.5 ns pulse duration in a 100 ns interval.

1. The signal of an uncoded, unmodulated pulse train may be expressed:

$$s ( t ) = a {\sum }_{i = 1}^{n} w ( c ( t - {iT}_{f} ) , b )$$

where i is the index of a pulse within a pulse train of n pulses, a is pulse amplitude, b is pulse type, c is a pulse width scaling parameter, w(t, b) is the normalized pulse waveform, and T_{f} is pulse repetition time, also referred to as frame time.

The Fourier transform of a pulse train signal over a frequency bandwidth of interest may be determined by summing the phasors of the pulses for each code time shift, and multiplying by the Fourier transform of the pulse function:

$$S ( f ) = a \vert {\sum }_{i = 1}^{n} {ⅇ}^{- j 2 π {fiT}_{f}} \vert W ( f )$$

where S(f) is the amplitude of the spectral response at a given frequency, f is the frequency being analyzed, T_{f} is the relative time delay of each pulse from the start of time period, W(f) is the Fourier transform of the pulse, w(t,b), and n is the total number of pulses in the pulse train.

A pulse train can also be characterized by its autocorrelation and cross-correlation properties. Autocorrelation properties pertain to the number of pulse coincidences (i.e., simultaneous arrival of pulses) that occur when a pulse train is correlated against an instance of itself that is offset in time. Of primary importance is the ratio of the number of pulses in the pulse train to the maximum number of coincidences that occur for any time offset across the period of the pulse train. This ratio is commonly referred to as the main-lobe-to-peak-side-lobe ratio, where the greater the ratio, the easier it is to acquire and track a signal.

Cross-correlation properties involve the potential for pulses from two different signals simultaneously arriving, or coinciding, at a receiver. Of primary importance are the maximum and average numbers of pulse coincidences that may occur between two pulse trains. As the number of coincidences increases, the propensity for data errors increases. Accordingly, pulse train cross-correlation properties are used in determining channelization capabilities of impulse transmission systems (i.e., the ability to simultaneously operate within close proximity).

Coding

Specialized coding techniques can be employed to specify temporal and/or non-temporal pulse characteristics to produce a pulse train having certain spectral and/or correlation properties. For example, by employing a Pseudo-Noise (PN) code to vary inter-pulse spacing, the energy in the uncoded comb lines presented in FIGS. 2B and 2C can be distributed to other frequencies as depicted in FIG. 2D, thereby decreasing the peak spectral density within a bandwidth of interest. Note that the spectrum retains certain properties that depend on the specific (temporal) PN code used. Spectral properties can be similarly affected by using non-temporal coding (e.g., inverting certain pulses).

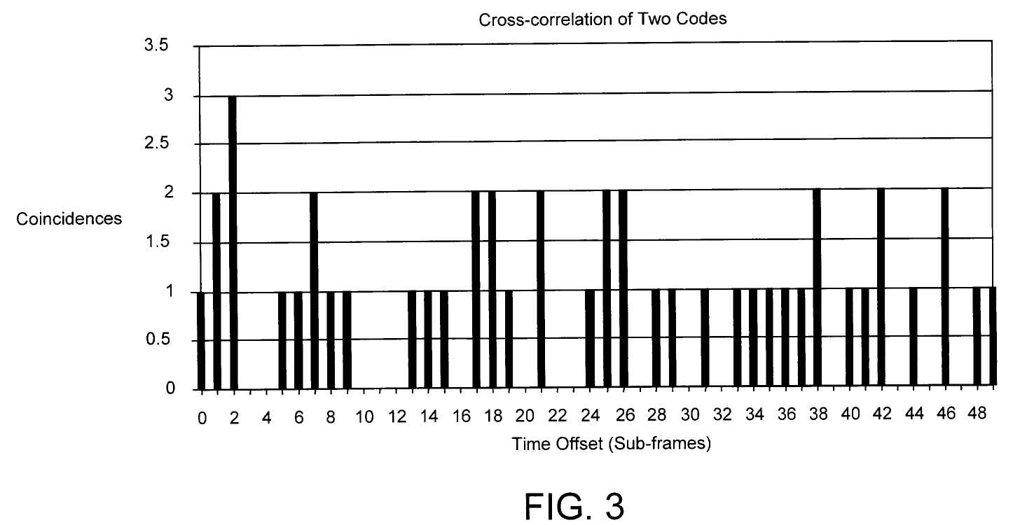

Coding provides a method of establishing independent communication channels. Specifically, families of codes can be designed such that the number of pulse coincidences between pulse trains produced by any two codes will be minimal. For example, FIG. 3 depicts cross-correlation properties of two codes that have no more than four coincidences for any time offset. Generally, keeping the number of pulse collisions minimal represents a substantial attenuation of the unwanted signal.

Coding can also be used to facilitate signal acquisition. For example, coding techniques can be used to produce pulse trains with a desirable main-lobe-to-side-lobe ratio. In addition, coding can be used to reduce acquisition algorithm search space.

Coding methods for specifying temporal and non-temporal pulse characteristics are described in commonly owned, co-pending applications titled “A Method and Apparatus for Positioning Pulses in Time,” application Ser. No. 09/592,249, and “A Method for Specifying Non-Temporal Pulse Characteristics,” application Ser. No. 09/592,250, both filed Jun. 12, 2000, and both of which are incorporated herein by reference.

Typically, a code consists of a number of code elements having integer or floating-point values. A code element value may specify a single pulse characteristic or may be subdivided into multiple components, each specifying a different pulse characteristic. Code element or code component values typically map to a pulse characteristic value layout that may be fixed or non-fixed and may involve value ranges, discrete values, or a combination of value ranges and discrete values. A value range layout specifies a range of values that is divided into components that are each subdivided into subcomponents, which can be further subdivided, as desired. In contrast, a discrete value layout involves uniformly or non-uniformly distributed discrete values. A non-fixed layout (also referred to as a delta layout) involves delta values relative to some reference value. Fixed and non-fixed layouts, and approaches for mapping code element/component values, are described in co-owned, co-pending applications, titled “Method for Specifying Pulse Characteristics using Codes,” application Ser. No. 09/592,290 and “A Method and Apparatus for Mapping Pulses to a Non-Fixed Layout,” application Ser. No. 09/591,691, both filed on Jun. 12, 2000, both of which are incorporated herein by reference.

A fixed or non-fixed characteristic value layout may include a non-allowable region within which a pulse characteristic value is disallowed. A method for specifying non-allowable regions is described in co-owned, co-pending application titled “A Method for Specifying Non-Allowable Pulse Characteristics,” application Ser. No. 09/592,289, filed Jun. 12, 2000, and incorporated herein by reference. A related method that conditionally positions pulses depending on whether code elements map to non-allowable regions is described in co-owned, co-pending application, titled “A Method and Apparatus for Positioning Pulses Using a Layout having Non-Allowable Regions,” application Ser. No. 09/592,248 filed Jun. 12, 2000, and incorporated herein by reference.

The signal of a coded pulse train can be generally expressed by:

$${s}_{tr} ( t ) = {\sum }_{i} {( - 1 )}^{{f}_{i}} {a}_{i} w ( {c}_{i} ( t - {T}_{i} ) , {b}_{i} )$$

where sₜᵣ(t) is the coded pulse train signal, i is the index of a pulse within the pulse train, (−1)^{ft} , aᵢ, bᵢ, cᵢ, and w(t,bᵢ) are the coded polarity, pulse amplitude, pulse type, pulse width, and normalized pulse waveform of the i'th pulse, and Tₜ is the coded time shift of the i^{th} pulse Various numerical code generation methods can be employed to produce codes having certain correlation and spectral properties. Detailed descriptions of numerical code generation techniques are included in a co-owned, co-pending patent application titled “A Method and Apparatus for Positioning Pulses in Time,” application Ser. No. 09/592,248, filed Jun. 12, 2000, and incorporated herein by reference.

It may be necessary to apply predefined criteria to determine whether a generated code, code family, or a subset of a code is acceptable for use with a given UWB application. Criteria may include correlation properties, spectral properties, code length, non-allowable regions, number of code family members, or other pulse characteristics. A method for applying predefined criteria to codes is described in co-owned, co-pending application, titled “A Method and Apparatus for Specifying Pulse Characteristics using a Code that Satisfies Predefined Criteria,” application Ser. No. 09/592,288, filed Jun. 12, 2000, and incorporated herein by reference.

In some applications, it may be desirable to employ a combination of codes. Codes may be combined sequentially, nested, or sequentially nested, and code combinations may be repeated. Sequential code combinations typically involve switching from one code to the next after the occurrence of some event and may also be used to support multicast communications. Nested code combinations may be employed to produce pulse trains having desirable correlation and spectral properties. For example, a designed code may be used to specify value range components within a layout and a nested pseudorandom code may be used to randomly position pulses within the value range components. With this approach, correlation properties of the designed code are maintained since the pulse positions specified by the nested code reside within the value range components specified by the designed code, while the random positioning of the pulses within the components results in particular spectral properties. A method for applying code combinations is described in co-owned, co-pending application, titled “A Method and Apparatus for Applying Codes Having Pre-Defined Properties,” application Ser. No. 09/591,690, filed Jun. 12, 2000, and incorporated herein by reference.

Modulation

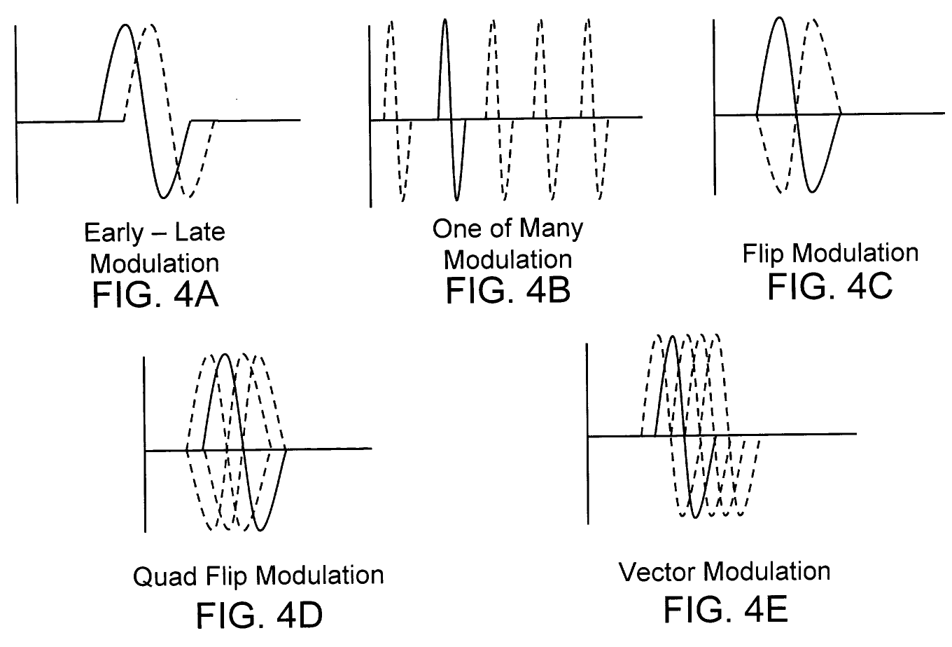

Various aspects of a pulse waveform may be modulated to convey information and to further minimize structure in the resulting spectrum. Amplitude modulation, phase modulation, frequency modulation, time-shift modulation and M-ary versions of these were proposed in U.S. Pat. No. 5,677,927 to Fullerton et al., previously incorporated by reference. Time-shift modulation can be described as shifting the position of a pulse either forward or backward in time relative to a nominal coded (or uncoded) time position in response to an information signal. Thus, each pulse in a train of pulses is typically delayed a different amount from its respective time base clock position by an individual code delay amount plus a modulation time shift. This modulation time shift is normally very small relative to the code shift. In a 10 Mpps system with a center frequency of 2 GHz, for example, the code may command pulse position variations over a range of 100 ns, whereas, the information modulation may shift the pulse position by 150 ps. This two-state ‘early-late’ form of time shift modulation is depicted in FIG. 4A.

A generalized expression for a pulse train with ‘early-late’ time-shift modulation over a data symbol time is:

$${s}_{tr} ( t ) = {{\sum }^{{N}_{s}}}_{i = 1} {( - 1 )}^{{f}_{i}} {a}_{i} w ( {c}_{i} ( t - {T}_{i} - δ {d}_{k} ) , {b}_{i} )$$

where k is the index of a data symbol (e.g., bit), i is the index of a pulse within the data symbol, Nₛ is the number of pulses per symbol, (−1)^{fi} is a coded polarity (flipping) pattern (sequence), aᵢ is a coded amplitude pattern, bᵢ is a coded pulse type (shape) pattern, cᵢ is a coded pulse width pattern, and w(t,bᵢ) is a normalized pulse waveform of the i^{th} pulse, Tⱼ⁾ is the coded time shift of the i'th pulse , δ is the time shift added when the transmitted symbol is 1 (instead of 0), dₖ is the data (i.e., 0 or 1) transmitted by the transmitter. In this example, the data value is held constant over the symbol interval. Similar expressions can be derived to accommodate other proposed forms of modulation.

An alternative form of time-shift modulation can be described as One-of-Many Position Modulation (OMPM). The OMPM approach, shown in FIG. 4B, involves shifting a pulse to one of N possible modulation positions about a nominal coded (or uncoded) time position in response to an information signal, where N represents the number of possible states. For example, if N were four (4), two data bits of information could be conveyed. For further details regarding OMPM, see “Apparatus, System and Method for One-of-Many Position Modulation in an Impulse Radio Communication System,” Attorney Docket No. 1659.0860000, filed Jun. 7, 2000, assigned to the assignee of the present invention, and incorporated herein by reference.

An impulse radio communications system can employ flip modulation techniques to convey information. The simplest flip modulation technique involves transmission of a pulse or an inverted (or flipped) pulse to represent a data bit of information, as depicted in FIG. 4C. Flip modulation techniques may also be combined with time-shift modulation techniques to create two, four, or more different data states. One such flip with shift modulation technique is referred to as Quadrature Flip Time Modulation (QFTM). The QFTM approach is illustrated in FIG. 4D. Flip modulation techniques are further described in patent application titled “Apparatus, System and Method for Flip Modulation in an Impulse Radio Communication System,” application Ser. No. 09/537,692, filed Mar. 29, 2000, assigned to the assignee of the present invention, and incorporated herein by reference.

Vector modulation techniques may also be used to convey information. Vector modulation includes the steps of generating and transmitting a series of time-modulated pulses, each pulse delayed by one of at least four pre-determined time delay periods and representative of at least two data bits of information, and receiving and demodulating the series of time-modulated pulses to estimate the data bits associated with each pulse. Vector modulation is shown in FIG. 4E. Vector modulation techniques are further described in patent application titled “Vector Modulation System and Method for Wideband Impulse Radio Communications,” application Ser. No. 09/169,765, filed Dec. 9, 1999, assigned to the assignee of the present invention, and incorporated herein by reference.

Reception and Demodulation

Impulse radio systems operating within close proximity to each other may cause mutual interference. While coding minimizes mutual interference, the probability of pulse collisions increases as the number of coexisting impulse radio systems rises. Additionally, various other signals may be present that cause interference. Impulse radios can operate in the presence of mutual interference and other interfering signals, in part because they typically do not depend on receiving every transmitted pulse. Except for single pulse per bit systems, impulse radio receivers perform a correlating, synchronous receiving function (at the RF level) that uses sampling and combining, or integration, of many pulses to recover transmitted information. Typically, 1 to 1000 or more pulses are integrated to yield a single data bit thus diminishing the impact of individual pulse collisions, where the number of pulses that must be integrated to successfully recover transmitted information depends on a number of variables including pulse rate, bit rate, range and interference levels.

Interference Resistance

Besides providing channelization and energy smoothing, coding makes impulse radios highly resistant to interference by enabling discrimination between intended impulse transmissions and interfering transmissions. This property is desirable since impulse radio systems must share the energy spectrum with conventional radio systems and with other impulse radio systems.

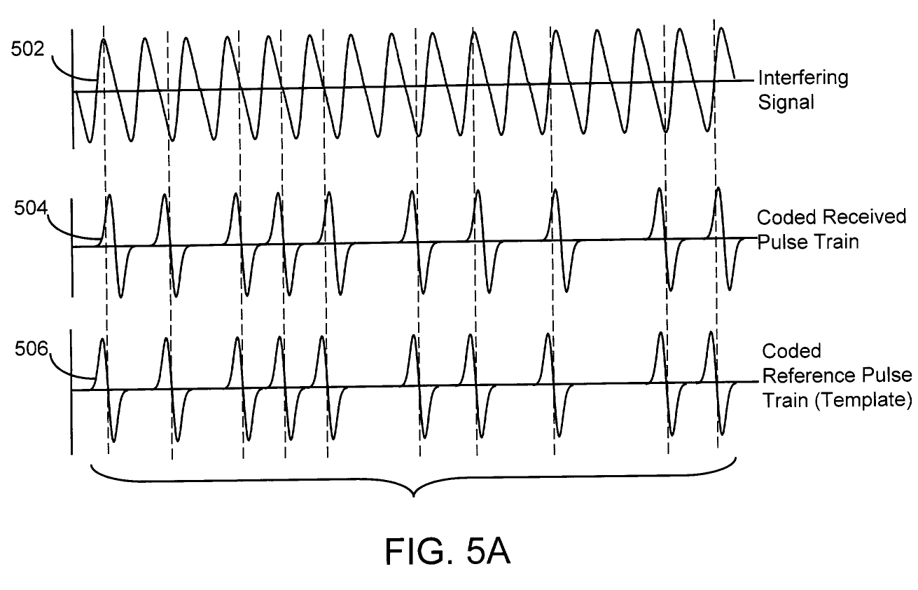

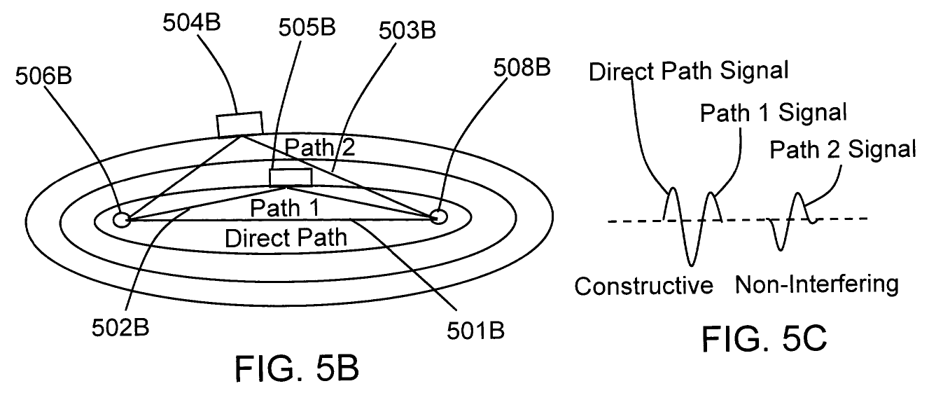

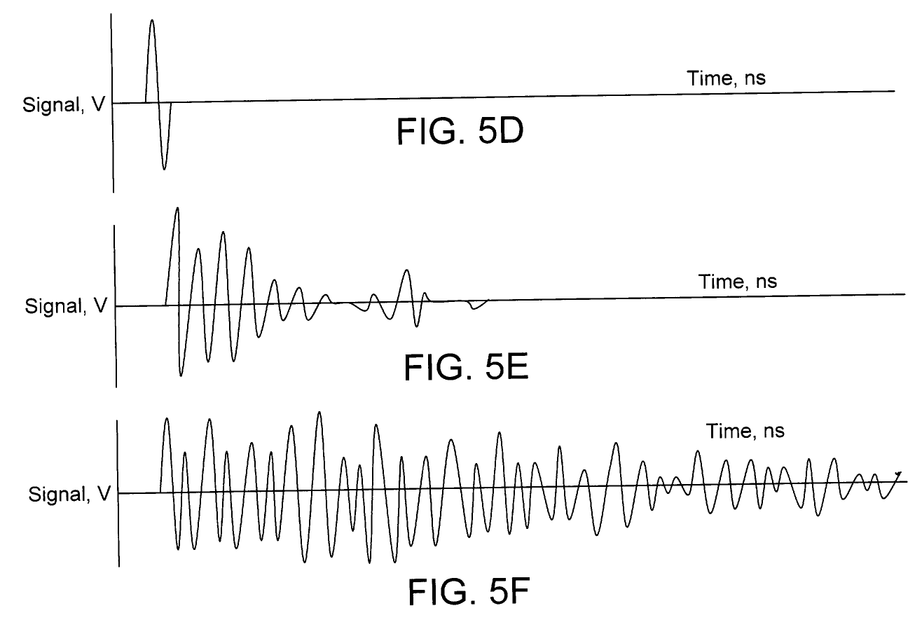

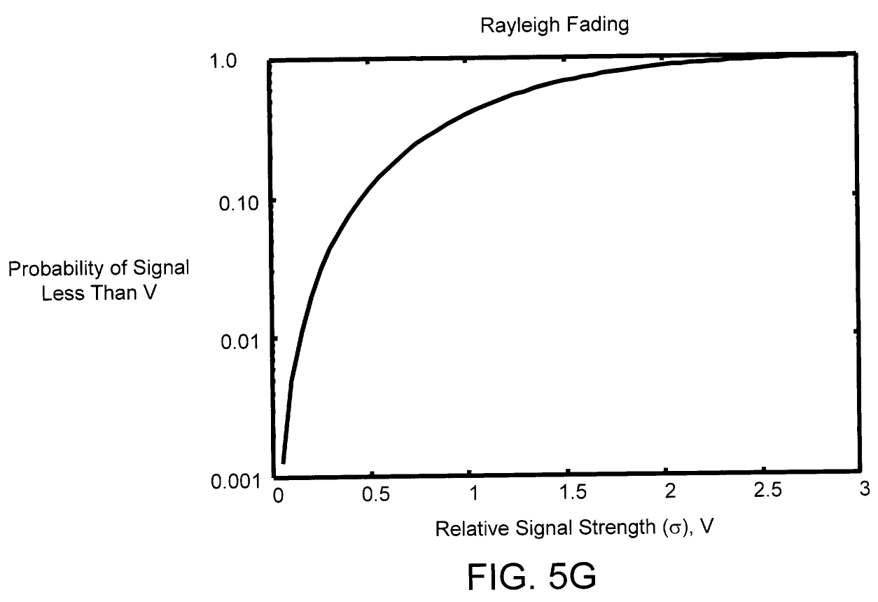

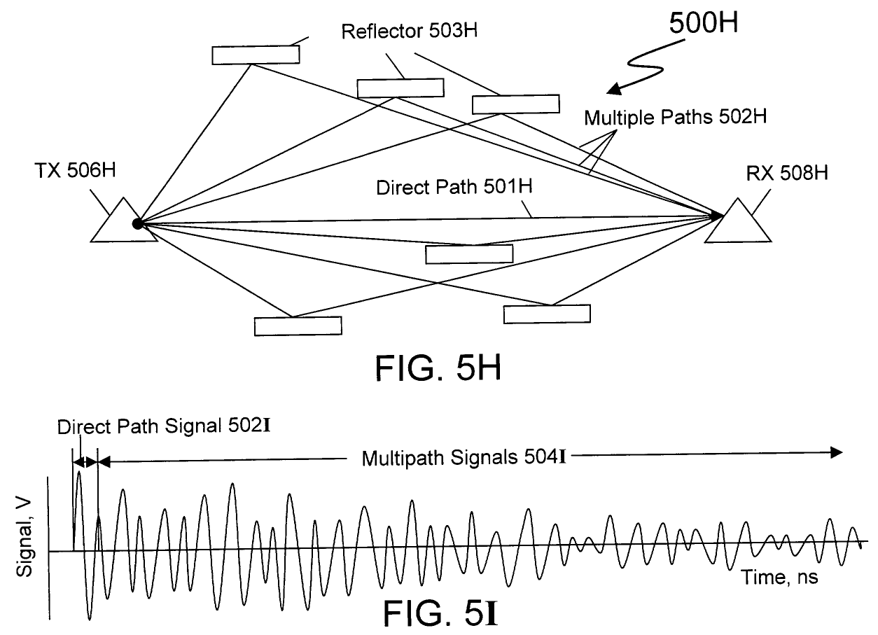

FIG. 5A illustrates the result of a narrow band sinusoidal interference signal 502 overlaying an impulse radio signal 504. At the impulse radio receiver, the input to the cross correlation would include the narrow band signal 502 and the received ultrawide-band impulse radio signal 504. The input is sampled by the cross correlator using a template signal 506 positioned in accordance with a code. Without coding, the cross correlation would sample the interfering signal 502 with such regularity that the interfering signals could cause interference to the impulse radio receiver. However, when the transmitted impulse signal is coded and the impulse radio receiver template signal 506 is synchronized using the identical code, the receiver samples the interfering signals non-uniformly. The samples from the interfering signal add incoherently, increasing roughly according to the square root of the number of samples integrated. The impulse radio signal samples, however, add coherently, increasing directly according to the number of samples integrated. Thus, integrating over many pulses overcomes the impact of interference.

Processing Gain

Impulse radio systems have exceptional processing gain due to their wide spreading bandwidth. For typical spread spectrum systems, the definition of processing gain, which quantifies the decrease in channel interference when wide-band communications are used, is the ratio of the bandwidth of the channel to the bit rate of the information signal. For example, a conventional narrow band direct sequence spread spectrum system with a 10 kbps data rate and a 10 MHz spread bandwidth yields a processing gain of 1000, or 30 dB. However, far greater processing gains are achieved by impulse radio systems, where the same 10 kbps data rate is spread across a much greater 2 GHz spread bandwidth, resulting in a theoretical processing gain of 200,000, or 53 dB.

Capacity

It can be shown theoretically, using signal-to-noise arguments, that for an impulse radio system with an information rate of a few tens of kbps, thousands of simultaneous channels could be available as a result of its exceptional processing gain.

The average output signal-to-noise ratio of a reference impulse radio receiver may be calculated for randomly selected time-hopping codes as a function of the number of active users, Nᵤ, as:

$${S}_{out} ( {N}_{u} ) = \frac{1}{\frac{1}{{S}_{out} ( 1 )} + \frac{1}{{N}_{s}} \frac{{σ}_{a}^{2}}{{m}_{p}^{2}} {\sum }_{k = 2}^{{N}_{u}} ( \frac{{A}_{k}}{{A}_{1}} )}$$

where Nₛ is the number of pulses integrated per bit of information, Aₗ is the received amplitude of the desired transmitter, Aₖ is the received amplitude of interfering transmitter k's signal at the reference receiver, and σ_{rec}² is the variance of the receiver noise component at the pulse train integrator output in the absence of an interfering transmitter. The waveform-dependent parameters mₚ and σₐ² are given by

$${m}_{p} = {\int }_{- ∞}^{∞} w ( t ) [ w ( t ) - w ( t - δ ) ] ⅆ t$$

$$and$$

$${σ}_{a}^{2} = {T}_{f}^{- 1} {\int }_{- ∞}^{∞} {[ {\int }_{- ∞}^{∞} w ( t - s ) υ ( t ) ⅆ t ]}^{2} ⅆ s ,$$

where w(t) is the transmitted waveform, v(t)=w(t)−w(t−δ) is the template signal waveform, δ is the modulation time shift between a digital one and a zero value data bit, T_{f} is the pulse repetition time, or frame time, and s is an integration parameter. The output signal to noise ratio that one might observe in the absence of interference is given by:

$${S}_{out} ( 1 ) = \frac{{( {A}_{1} {N}_{s} {m}_{p} )}^{2}}{{σ}_{rec}^{2}}$$

Where, σ_{rec}² is the variance of the receiver noise component at the pulse train integrator output in the absence of an interfering transmitter. Further details of this analysis can be found in R. A. Scholtz, “Multiple Access with Time-Hopping Impulse Modulation,” Proc. MILCOM, Boston, Mass., Oct. 11-14, 1993.

Multipath and Propagation

One of the advantages of impulse radio is its resistance to multipath fading effects. Conventional narrow band systems are subject to multipath through the Rayleigh fading process, where the signals from many delayed reflections combine at the receiver antenna according to their seemingly random relative phases resulting in possible summation or possible cancellation, depending on the specific propagation to a given location. Multipath fading effects are most adverse where a direct path signal is weak relative to multipath signals, which represents a substantial portion of the potential coverage area of a typical radio system. In a mobile system, received signal strength fluctuates due to the changing mix of multipath signals that vary as the mobile units position varies relative to fixed transmitters, other mobile transmitters and signal-reflecting surfaces in the environment.

Impulse radios, however, can be substantially resistant to multipath effects. Impulses arriving from delayed multipath reflections typically arrive outside of the correlation time and, thus, may be ignored. This process is described in detail with reference to FIGS. 5B and 5C. FIG. 5B illustrates a typical multipath situation, such as in a building, where there are many reflectors 504B, 505B. In this figure, a transmitter 506B transmits a signal that propagates along three paths, the direct path 501B, path 1 502B, and path 2 503B, to a receiver 508B, where the multiple reflected signals are combined at the antenna. The direct path 501B, representing the straight-line distance between the transmitter and receiver, is the shortest. Path 1 502B represents a multipath reflection with a distance very close to that of the direct path. Path 2 503B represents a multipath reflection with a much longer distance. Also shown are elliptical (or, in space, ellipsoidal) traces that represent other possible locations for reflectors that would produce paths having the same distance and thus the same time delay.

FIG. 5C illustrates the received composite pulse waveform resulting from the three propagation paths 501B, 502B, and 503B shown in FIG. 5B. In this figure, the direct path signal 501B is shown as the first pulse signal received. The path 1 and path 2 signals 502B, 503B comprise the remaining multipath signals, or multipath response, as illustrated. The direct path signal is the reference signal and represents the shortest propagation time. The path 1 signal is delayed slightly and overlaps and enhances the signal strength at this delay value. The path 2 signal is delayed sufficiently that the waveform is completely separated from the direct path signal. Note that the reflected waves are reversed in polarity. If the correlator template signal is positioned such that it will sample the direct path signal, the path 2 signal will not be sampled and thus will produce no response. However, it can be seen that the path 1 signal has an effect on the reception of the direct path signal since a portion of it would also be sampled by the template signal. Generally, multipath signals delayed less than one quarter wave (one quarter wave is about 1.5 inches, or 3.5 cm at 2 GHz center frequency) may attenuate the direct path signal. This region is equivalent to the first Fresnel zone in narrow band systems. Impulse radio, however, has no further nulls in the higher Fresnel zones. This ability to avoid the highly variable attenuation from multipath gives impulse radio significant performance advantages.

FIGS. 5D, 5E, and 5F represent the received signal from a TM-UWB transmitter in three different multipath environments. These figures are approximations of typical signal plots. FIG. 5D illustrates the received signal in a very low multipath environment. This may occur in a building where the receiver antenna is in the middle of a room and is a relatively short, distance, for example, one meter, from the transmitter. This may also represent signals received from a larger distance, such as 100 meters, in an open field where there are no objects to produce reflections. In this situation, the predominant pulse is the first received pulse and the multipath reflections are too weak to be significant. FIG. 5E illustrates an intermediate multipath environment. This approximates the response from one room to the next in a building. The amplitude of the direct path signal is less than in FIG. 5D and several reflected signals are of significant amplitude. FIG. 5F approximates the response in a severe multipath environment such as propagation through many rooms, from corner to corner in a building, within a metal cargo hold of a ship, within a metal truck trailer, or within an intermodal shipping container. In this scenario, the main path signal is weaker than in FIG. 5E. In this situation, the direct path signal power is small relative to the total signal power from the reflections.

An impulse radio receiver can receive the signal and demodulate the information using either the direct path signal or any multipath signal peak having sufficient signal-to-noise ratio. Thus, the impulse radio receiver can select the strongest response from among the many arriving signals. In order for the multipath signals to cancel and produce a null at a given location, dozens of reflections would have to be cancelled simultaneously and precisely while blocking the direct path, which is a highly unlikely scenario. This time separation of multipath signals together with time resolution and selection by the receiver permit a type of time diversity that virtually eliminates cancellation of the signal. In a multiple correlator rake receiver, performance is further improved by collecting the signal power from multiple signal peaks for additional signal-to-noise performance.

In a narrow band system subject to a large number of multipath reflections within a symbol (bit) time, the received signal is essentially a sum of a large number of sine waves of random amplitude and phase. In the idealized limit, the resulting envelope amplitude has been shown to follow a Rayleigh probability density as follows:

$$p ( r ) = \frac{r}{{σ}^{2}} exp ( \frac{- {r}^{2}}{2 {σ}^{2}} )$$

where r is the envelope amplitude of the combined multipath signals, and 2σ² is the expected value of the envelope power of the combined multipath signals. The Rayleigh distribution curve in FIG. 5G shows that 10% of the time, the signal is more than 10 dB attenuated. This suggests that a 10 dB fade margin is needed to provide 90% link reliability. Values of fade margin from 10 dB to 40 dB have been suggested for various narrow band systems, depending on the required reliability. Although multipath fading can be partially improved by such techniques as antenna and frequency diversity, these techniques result in additional complexity and cost.

In a high multipath environment such as inside homes, offices, warehouses, automobiles, trailers, shipping containers, or outside in an urban canyon or in other situations where the propagation is such that the received signal is primarily scattered energy, impulse radio systems can avoid the Rayleigh fading mechanism that limits performance of narrow band systems, as illustrated in FIGS. 5H and 5I. FIG. 5H depicts an impulse radio system in a high multipath environment 500H consisting of a transmitter 506H and a receiver 508H. A transmitted signal follows a direct path 501H and reflects off of reflectors 503H via multiple paths 502H. FIG. 51 illustrates the combined signal received by the receiver 508H over time with the vertical axis being signal strength in volts and the horizontal axis representing time in nanoseconds. The direct path 501H results in the direct path signal 502I while the multiple paths 502H result in multipath signals 504I. UWB system can thus resolve the reflections into separate time intervals which can be received separately. Thus, the UWB system can select the strongest or otherwise most desirable reflection from among the numerous reflections. This yields a multipath diversity mechanism with numerous paths making it highly resistant to Rayleigh fading. Whereas, in a narrow band systems, the reflections arrive within the minimum time resolution of one bit or symbol time which results in a single vector summation of the delayed signals with no inherent diversity.

Distance Measurement and Positioning

Impulse systems can measure distances to relatively fine resolution because of the absence of ambiguous cycles in the received waveform. Narrow band systems, on the other hand, are limited to the modulation envelope and cannot easily distinguish precisely which RF cycle is associated with each data bit because the cycle-to-cycle amplitude differences are so small they are masked by link or system noise. Since an impulse radio waveform has minimal multi-cycle ambiguity, it is feasible to determine waveform position to less than a wavelength in the presence of noise. This time position measurement can be used to measure propagation delay to determine link distance to a high degree of precision. For example, 30 ps of time transfer resolution corresponds to approximately centimeter distance resolution. See, for example, U.S. Pat. No. 6,133,876, issued Oct. 17, 2000, titled “System and Method for Position Determination by Impulse Radio,” and U.S. Pat. No. 6,111,536, issued Aug. 29, 2000, titled “System and Method for Distance Measurement by Inphase and Quadrature Signals in a Radio System,” both of which are incorporated herein by reference.

In addition to the methods articulated above, impulse radio technology in a Time Division Multiple Access (TDMA) radio system can achieve geo-positioning capabilities to high accuracy and fine resolution. This geo-positioning method is described in U.S. Pat. No. 6,300,903, issued Oct. 9, 2001, titled “System and Method for Person or Object Position Location Utilizing Impulse Radio,” which is incorporated herein by reference.

Power Control

Power control systems comprise a first transceiver that transmits an impulse radio signal to a second transceiver. A power control update is calculated according to a performance measurement of the signal received at the second transceiver. The transmitter power of either transceiver, depending on the particular setup, is adjusted according to the power control update. Various performance measurements are employed to calculate a power control update, including bit error rate, signal-to-noise ratio, and received signal strength, used alone or in combination. Interference is thereby reduced, which may improve performance where multiple impulse radios are operating in close proximity and their transmissions interfere with one another. Reducing the transmitter power of each radio to a level that produces satisfactory reception increases the total number of radios that can operate in an area without mutial interference. Reducing transmitter power can also increase transceiver efficiency.

For greater elaboration of impulse radio power control, see patent application titled “System and Method for Impulse Radio Power Control,” application Ser. No. 09/332,501, filed Jun. 14, 1999, assigned to the assignee of the present invention, and incorporated herein by reference.

Exemplary Transceiver Implementation

Transmitter

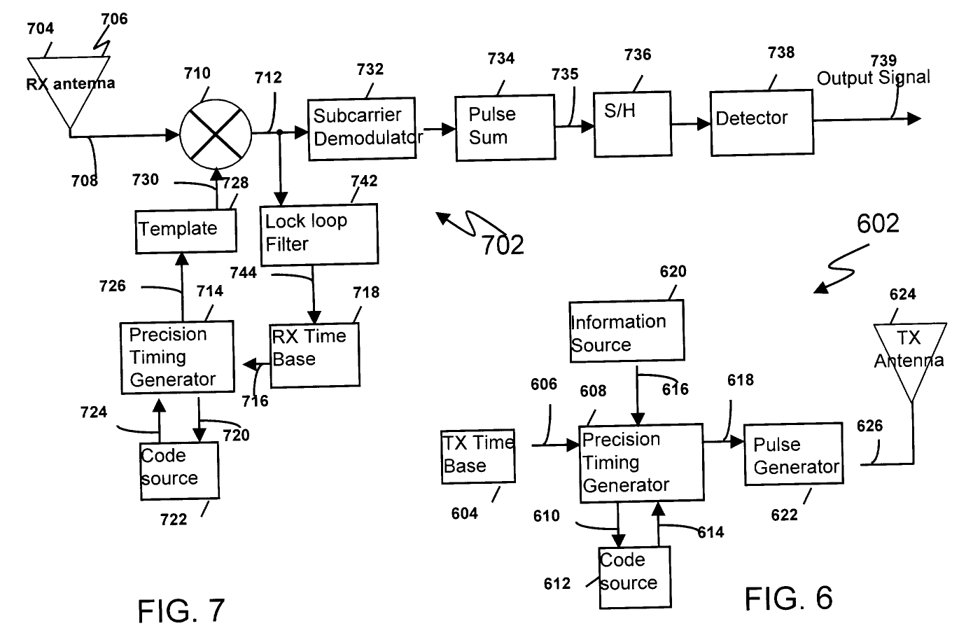

An exemplary embodiment of an impulse radio transmitter 602 of an impulse radio communication system having an optional subcarrier channel will now be described with reference to FIG. 6.

The transmitter 602 comprises a time base 604 that generates a periodic timing signal 606. The time base 604 typically comprises a voltage controlled oscillator (VCO), or the like, having a high timing accuracy and low jitter. The control voltage to adjust the VCO center frequency is set at calibration to the desired center frequency used to define the transmitter's nominal pulse repetition rate. The periodic timing signal 606 is supplied to a precision timing generator 608.

The precision timing generator 608 supplies synchronizing signals 610 to the code source 612 and utilizes the code source output 614, together with an optional, internally generated subcarrier signal, and an information signal 616, to generate a modulated, coded timing signal 618.

An information source 620 supplies the information signal 616 to the precision timing generator 608. The information signal 616 can be any type of intelligence, including digital bits representing voice, data, imagery, or the like, analog signals, or complex signals.

A pulse generator 622 uses the modulated, coded timing signal 618 as a trigger signal to generate output pulses. The output pulses are provided to a transmit antenna 624 via a transmission line 626 coupled thereto. The output pulses are converted into propagating electromagnetic pulses by the transmit antenna 624. The electromagnetic pulses (also called the emitted signal) propagate to an impulse radio receiver 702, such as shown in FIG. 7, through a propagation medium. In a preferred embodiment, the emitted signal is wide-band or ultrawide-band, approaching a monocycle pulse as in FIG. 1B. However, the emitted signal may be spectrally modified by filtering of the pulses, which may cause them to have more zero crossings (more cycles) in the time domain, requiring the radio receiver to use a similar waveform as the template signal for efficient conversion.

Receiver

An exemplary embodiment of an impulse radio receiver (hereinafter called the receiver) for the impulse radio communication system is now described with reference to FIG. 7.

The receiver 702 comprises a receive antenna 704 for receiving a propagated impulse radio signal 706. A received signal 708 is input to a cross correlator or sampler 710, via a receiver transmission line, coupled to the receive antenna 704. The cross correlation 710 produces a baseband output 712.

The receiver 702 also includes a precision timing generator 714, which receives a periodic timing signal 716 from a receiver time base 718. This time base 718 may be adjustable and controllable in time, frequency, or phase, as required by the lock loop in order to lock on the received signal 708. The precision timing generator 714 provides synchronizing signals 720 to the code source 722 and receives a code control signal 724 from the code source 722. The precision timing generator 714 utilizes the periodic timing signal 716 and code control signal 724 to produce a coded timing signal 726. The template generator 728 is triggered by this coded timing signal 726 and produces a train of template signal pulses 730 ideally having waveforms substantially equivalent to each pulse of the received signal 708. The code for receiving a given signal is the same code utilized by the originating transmitter to generate the propagated signal. Thus, the timing of the template pulse train matches the timing of the received signal pulse train, allowing the received signal 708 to be synchronously sampled in the correlator 710. The correlator 710 preferably comprises a multiplier followed by a short term integrator to sum the multiplier product over the pulse interval.

The output of the correlator 710 may be coupled to an optional subcarrier demodulator 732, which demodulates the subcarrier information signal from the optional subcarrier, when used. The purpose of the optional subcarrier process, when used, is to move the information signal away from DC (zero frequency) to improve immunity to low frequency noise and offsets. The output of the subcarrier demodulator is then filtered or integrated in the pulse summation stage 734. A digital system embodiment is shown in FIG. 7. In this digital system, a sample and hold 736 samples the output 735 of the pulse summation stage 734 synchronously with the completion of the summation of a digital bit or symbol. The output of sample and hold 736 is then compared with a nominal zero (or reference) signal output in a detector stage 738 to provide an output signal 739 representing the digital state of the output voltage of sample and hold 736.

The baseband signal 712 is also input to a lowpass filter 742 (also referred to as lock loop filter 742). A control loop comprising the lowpass filter 742, time base 718, precision timing generator 714, template generator 728, and correlator 710 is used to maintain proper timing between the received signal 708 and the template. The loop error signal 744 is processed by the loop filter to provide adjustments to the adjustable time base 718 to correct the relative time position of the periodic timing signal 726 for best reception of the received signal 708.

In a transceiver embodiment, substantial economy can be achieved by sharing part or all of several of the functions of the transmitter 602 and receiver 702. Some of these include the time base 718, precision timing generator 714, code source 722, antenna 704, and the like.

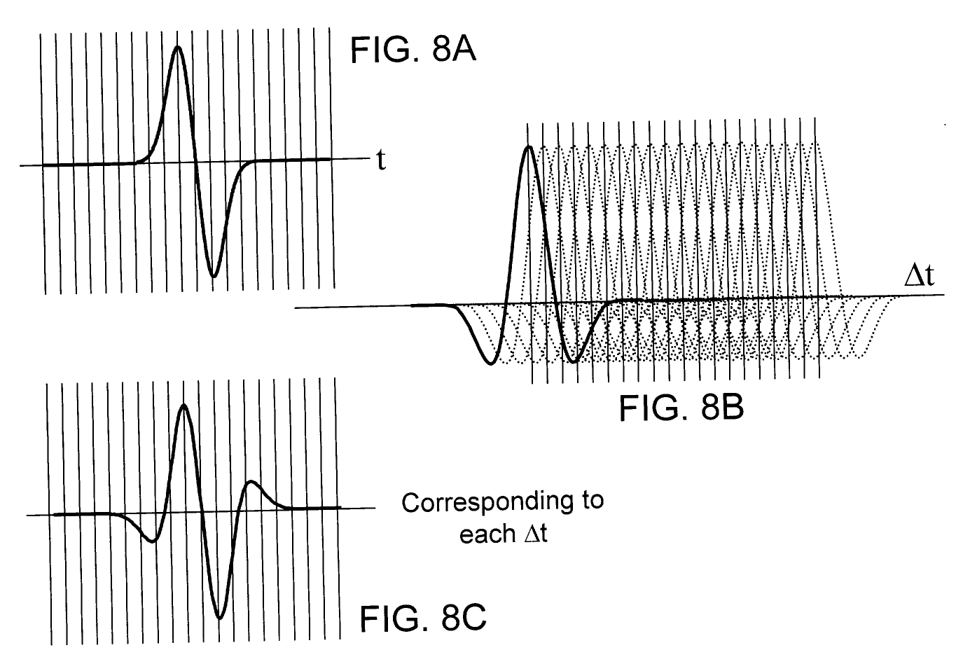

FIGS. 8A-8C illustrate the cross correlation process and the correlation function. FIG. 8A shows the waveform of a template signal. FIG. 8B shows the waveform of a received impulse radio signal at a set of several possible time offsets. FIG. 8C represents the output of the cross correlator for each of the time offsets of FIG. 8B. For any given pulse received, there is a corresponding point that is applicable on this graph. This is the point corresponding to the time offset of the template signal used to receive that pulse. Further examples and details of precision timing can be found described in U.S. Pat. No. 5,677,927 and U.S. Pat. No. 6,304,623, issued Oct. 16, 2001, titled “Precision Timing Generator System and Method,” both of which are incorporated herein by reference.

Because of the unique nature of impulse radio receivers, several modifications have been recently made to enhance system capabilities. Modifications include the utilization of multiple correlators to measure the impulse response of a channel to the maximum communications range of the system and to capture information on data symbol statistics. Further, multiple correlators enable rake pulse correlation techniques, more efficient acquisition and tracking implementations, various modulation schemes, and collection of time-calibrated pictures of received waveforms. For greater elaboration of multiple correlator techniques, see patent application titled “System and Method of using Multiple Correlator Receivers in an Impulse Radio System”, application Ser. No. 09/537,264, filed Mar. 29, 2000, assigned to the assignee of the present invention, and incorporated herein by reference.

Methods to improve the speed at which a receiver can acquire and lock onto an incoming impulse radio signal have been developed. In one approach, a receiver includes an adjustable time base to output a sliding periodic timing signal having an adjustable repetition rate and a decode timing modulator to output a decode signal in response to the periodic timing signal. The impulse radio signal is cross-correlated with the decode signal to output a baseband signal. The receiver integrates T samples of the baseband signal and a threshold detector uses the integration results to detect channel coincidence. A receiver controller stops sliding the time base when channel coincidence is detected. A counter and extra count logic, coupled to the controller, are configured to increment or decrement the address counter by one or more extra counts after each T pulses is reached in order to shift the code modulo for proper phase alignment of the periodic timing signal and the received impulse radio signal. This method is described in more detail in U.S. Pat. No. 5,832,035 to Fullerton, incorporated herein by reference.

In another approach, a receiver obtains a template pulse train and a received impulse radio signal. The receiver compares the template pulse train and the received impulse radio signal. The system performs a threshold check on the comparison result. If the comparison result passes the threshold check, the system locks on the received impulse radio signal. The system may also perform a quick check, a synchronization check, and/or a command check of the impulse radio signal. For greater elaboration of this approach, see the patent application titled “Method and System for Fast Acquisition of Ultra Wideband Signals,” application Ser. No. 09/538,292, filed Mar. 29, 2000, assigned to the assignee of the present invention, and incorporated herein by reference.

A receiver has been developed that includes a baseband signal converter device and combines multiple converter circuits and an RF amplifier in a single integrated circuit package. For greater elaboration of this receiver, see US. Pat. No. 6,421,389, issued Jul. 16, 2002, titled “Baseband Signal Converter for a Wideband Impulse Radio Receiver,” assigned to the assignee of the present invention, and incorporated herein by reference.

Elaboration of Ultra Wideband in the Present Invention

Referring back to FIG. 9, system 900 permits remote control device 918 to utilize ultra wideband wireless communication link 920 to transmit control signals to mobile telephone 938, for example, to place a call, or to receive control signals from mobile telephone 938, for example, to answer a call. Remote control device 918 may transmit one or more control signals to mobile telephone 938 to elicit many types of responses from mobile telephone 938. In addition to placing a call or receiving a call, such a response might be to determine the status of mobile telephone 938, to activate circuitry in mobile telephone 938, to receive any information about mobile telephone 938 or to control mobile telephone 938.

If a user desires to place a call from remote control device 918 using mobile telephone 938, the user depresses button 910 to establish an ultra wideband wireless communication link 920. Upon depressing button 910, the state machine 916 provides suitable control signals to the ultra wideband wireless link circuitry 902 that cause the ultra wideband wireless link circuitry 902 to establish ultra wideband wireless communication link 920 with its counterpart ultra wideband wireless link circuitry 924 coupled to the mobile telephone 938. The ultra wideband wireless communication link 920 is preferably established as a voice and data link.

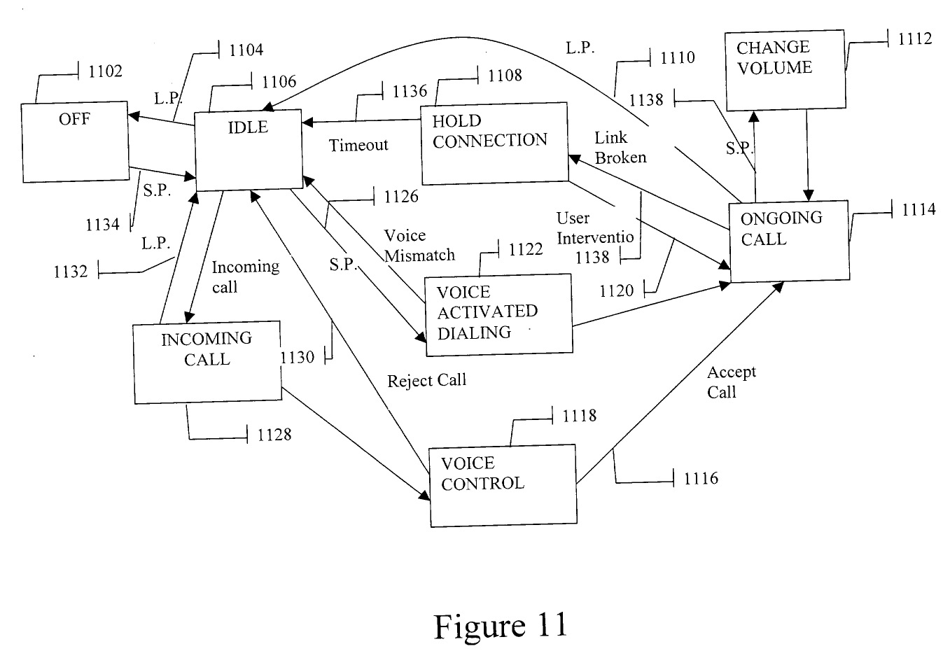

Once ultra wideband wireless communication link 920 is established, mobile telephone 938 returns a control signal indicating the operational status of the phone. The phone status may be “idle” if mobile telephone 938 is not currently in communication with another device over ultra wideband wireless communication link 940. Other mobile telephone states include “incoming call” and “ongoing call”. As the status changes, mobile telephone 938 communicates this new status information to remote control device 918 via the ultra wideband wireless communication link 920. These statuses, and other control signals are discussed in more detail below with reference to FIG. 11. Mobile telephone 938 also returns an “OK” control signal indicating that mobile telephone 938 is capable of receiving additional control signals from remote control device 918. The user may then supply a voice command, e.g., “Call Mom,” to microphone 908. The voice command is supplied to an analog-to-digital (A/D) converter 914, which converts the analog voice command into a digital voice signal. The digital voice signal travels from A/D converter 914 to ultra wideband wireless link circuitry 902.

After suitable modulation and encoding, the digital voice signal travels from ultra wideband wireless link circuitry 902 and antenna 912 to antenna 922 over wireless communication link 920. Antenna 922 receives the digital voice signal and sends the digital voice signal to wireless link circuitry 924. After suitable demodulation and decoding (as required), link circuitry 924 transmits the digital voice signal to voice control circuitry 932. Voice control circuitry 932 includes a digital signal processor, voice recognition algorithms, stored voice signals, voice comparison algorithms and voice instruction tables for analyzing the digital voice signal as discussed above. Voice control circuitry 932 may operate, for example, by receiving the digital voice signal and comparing the digital voice signal with stored voice signals. Voice control circuitry 932 then determines if the digital voice signal is sufficiently similar to any of the stored voice signals. If the determination reveals a match, voice control circuitry 932 generates instructions, or other data, associated with the similar stored voice signal, such as “Mom's” telephone number. Mobile telephone 938 then initiates communication over ultra wideband wireless communication link 940 utilizing Mom's telephone number. As mentioned earlier, ultra wideband wireless communication link 940 may be a GSM connection or any other mobile telephone communication link. Assuming that she answers her telephone, thereby completing establishment of the ultra wideband wireless communication link 940, voice signals from “Mom” are transmitted from her telephone via ultra wideband wireless communication to the mobile telephone 938, and then (after suitable modulation and possible encoding) from mobile telephone 938 to remote control device 918 over ultra wideband wireless communication link 920. The voice signals are transmitted from antenna 912 to wireless link circuitry 902 which performs suitable demodulation and decoding, and then supplies the resultant voice signals to speaker 906. If the voice signals are digital, the digital voice signals are converted to analog voice signals by digital-to-analog (D/A) converter 904 prior to being supplied to speaker 906.

If the determination does not reveal a match, no instructions are generated and no communication over ultra wideband wireless communication link 940 occurs.

Providing voice control circuitry 932 in mobile telephone 938 is advantageous over providing voice control circuitry in remote control device 918 because mobile telephone 938 typically has more processing power than remote control device 918. In addition, providing voice control circuitry 932 in mobile telephone 938 rather than in remote control device 918 enables remote control device 918 to be lighter and smaller.

As stated above, system 900 also permits remote control device 918 to utilize ultra wideband wireless communication link 920 to receive control signals from mobile telephone 938, for example, to answer a call coming over ultra wideband wireless communication link 940. In this case, it is mobile telephone 938 that establishes ultra wideband wireless communication link 920 with remote control device 918 by exchanging control signals in a manner similar to that described above. Ultra wideband wireless communication link 920 is a voice and data link. The user can decide to answer the call or not to answer the call. In the event that the user desires to answer the call, the user depresses button 910 with a short keypress, or gives a voice command to that effect. If a keypress is given, state machine 916 generates suitable control signals for causing ultra wideband wireless link circuitry 902 to transmit suitable control signals to mobile telephone to indicate that the call is accepted. If a voice command is given, the voice command is converted from an analog signal to a digital signal in A/D converter 914 and transmitted to mobile telephone 938 in a manner similar to that described above. In this case, voice control circuitry 932 recognizes that the user has accepted the call, and responds by generating suitable signals for causing state machine 934 to perform necessary actions for completing establishment of the ultra wideband wireless communication. The informational content of the call is subsequently transmitted from mobile telephone 938 to remote control device 918, where the user can hear it via loudspeaker 906. The user's voice is similarly picked up via microphone 908 and conveyed to the mobile telephone 938 via ultra wideband wireless communication link 920. The mobile telephone 938 forwards this voice information to the other (calling) party via ultra wideband wireless communication link 940.

If the user desires not to answer the call, the user depresses button 910 with a long keypress, or gives a voice command to that effect. If a keypress is given, state machine 916 causes remote control device 918 to transmit corresponding control signals to mobile telephone 938 to indicate that the call is rejected. If, alternatively, a voice command is given, the voice command is converted from an analog signal to a digital signal in A/D converter 914 and transmitted to mobile telephone 938 in a manner similar to that described above. The mobile telephone 938 then takes appropriate actions in response to control signals generated by the voice control circuitry acting in conjunction with state machine 934. Having declined to accept the call, no call-related (e.g., voice) information would be transmitted to remote control device 918.

The embodiment depicted in FIG. 10 is identical to that depicted in FIG. 9, except for the incorporation of ultra wideband wireless link circuitry 1024 within the mobile telephone 1038. In this case, it is unnecessary to utilize a connector for coupling signals between circuitry within the mobile telephone 1038 and the ultra wideband wireless link circuitry 1024. The ultra wideband wireless link circuitry 1024 otherwise operates the same as the ultra wideband wireless link circuitry 924 described above. Furthermore, the remaining components of FIG. 10 operate the same as their counterparts which are described above with reference to FIG. 9. Accordingly, no further description of FIG. 10 need be given here. Furthermore, in the following discussion, reference is made to components illustrated in FIG. 9. It should be recognized, however, that these references could also be made to counterpart components illustrated in FIG. 10.

FIG. 11 shows a state diagram of state transitions carried out by state machine 916 of remote control device 918 according to an embodiment of the present invention. With reference to both FIGS. 1 and 3, the various states of state machine 916 will now be described. State machine 916 begins in state OFF 1102. When a user desires to use remote control device 918 to place a call through mobile telephone 938, the user depresses button 910 for a short press 1134 to establish short-range wireless communication link 920. A short press requires depressing button 910 for a short amount of time relative to a long press. For example, a short press might require user contact with button 910 for less than two seconds, while a long press might require user contact with button 910 for more than two seconds.

In the following discussion, signaling between the remote control device 918 and the mobile communication device 104 is described. In all communications between remote control device 918 and mobile telephone 938, it is presumed that ultra wideband wireless communication link 920/236 is utilized. Furthermore, unless otherwise specified, control signals received by the remote control device 918 and the mobile telephone 938 are decoded by their respective state machines 114, 130, which generate suitable internal control signals and next states based on a present state and the received control signal. In each of the remote control device 918 and mobile telephone 938, the internal control signals cause the respective device to operate in a desired way, possibly including generation and transmission of other control signals.

Upon depressing button 910 for short press 1134, state machine 916 causes ultra wideband wireless link circuitry 902 to transmit a control signal, such as AT command AT+CPAS, to mobile telephone 938. In response, mobile telephone 938 transmits a control signal, such as AT command AT+CPAS:n to remote control device 918. The “n” indicates the operational status of mobile telephone 938. Mobile telephone 938 may have a status of idle 1104, incoming call 1128, or ongoing call 1114. Remote control device 918 stores the operational status in memory (not shown). Mobile telephone 938 then transmits to remote control device 918 an “OK” signal indicating that communication between remote control device 918 and mobile telephone 938 can proceed.

Remote control device 918 then sends a control signal, such as AT command AT*ECAM=1, instructing mobile telephone 938 to transmit control signals, such as AT command *ECAV, to remote control device 918 indicating that the telephone status is changed, if applicable. Mobile telephone 938 then transmits to remote control device 918 an “OK” signal. In the event a control signal, such as AT command *ECAV, is received from mobile telephone 938 indicating that the telephone status has changed, state machine 916 changes states accordingly to match the changed telephone status.

When mobile telephone 938 is in an idle state 1106, remote control device 918 may transmit different control signals to alternatively initiate a call using voice activated dialing 1122, receive an incoming call 1128, or terminate wireless communication link 920.

In some embodiments, there may be no available dedicated command to initiate voice activated dialing 1122. In this case, it is necessary to emulate key strokes to initiate voice activated dialing 1122. In this case, the user depresses button 910 with a short press 1126. Upon depressing button 910, remote control device 918 transmits one or more control signals. Remote control device 918 may first confirm that the phone is in the idle state. To do so, remote control device 918 transmits a control signal, such as AT command, AT+CKPD=“EEEE”, to emulate four presses of a NO button, or any other suitable button, for exiting menus of mobile telephone 938. Mobile telephone 938 then transmits to remote control device 918 an “OK” signal indicating that communication between remote control device 918 and mobile telephone 938 can proceed.

Remote control device 918 then transmits a control signal, such as AT command AT+CKPD=“S”,40, to simulate a long keypress of a YES button, or any other suitable button, of mobile telephone 938.l Mobile telephone 938 receives the control signal and accordingly activates voice control circuitry 932. Mobile telephone 938 then transmits to remote control device 918 an “OK” signal indicating that voice control circuitry 932 has been activated and that communication between remote control device 918 and mobile telephone 938 can proceed.

In other embodiments, it may be necessary to emulate more or fewer presses, depending upon the particular configuration of the mobile telephone 938.

Alternatively, remote control device 918 may transmit a control signal which initiates voice activated dialing directly without emulating keypresses as discussed above. For example, to initiate voice activated dialing 1122, the user depresses button 910 with a short press 1126. Upon depressing button 910, remote control device 918 transmits a control signal, such as AT command AT*EVAD, to mobile telephone 938. Mobile telephone 938 receives the control signal and accordingly activates voice control circuitry 932. Mobile telephone 938 then transmits to remote control device 918 an “OK” signal indicating that voice control circuitry 932 has been activated and that communication between remote control device 918 and mobile telephone 938 can proceed.

Once the voice activated dialing 1122 is initiated, the user can supply a voice command or signal to microphone 908 indicating the name of a third party such as a person, business or other entity, that the user desires to contact. The voice signal is converted to a digital voice signal and is transmitted to mobile telephone 938 as described above. If mobile telephone 938 establishes ultra wideband wireless communication link 940 with the third party, mobile telephone 938 enters the ongoing call status 1114. Mobile telephone 938 transmits to remote control device 918 the third party voice signals received over ultra wideband wireless communication link 940. These third party voice signals are transmitted to speaker 906.

In the event the voice signal is not recognized by voice control circuitry 932, the call is not placed to the third party. Mobile telephone 938 returns to idle status 1106 and transmits a signal to remote control device 918 indicating that no call was placed.

While in ongoing call status 1114, the user may adjust the volume of voice signals being received from mobile telephone 938. By depressing button 910 with one or more short presses 1138, and entering change volume status 314, a control signal, such as an AT command, can be sent to mobile telephone 938 to change the amplitude of the third party voice signals. Alternatively, by depressing button 910, a control signal is transmitted to circuitry within remote control device 918 to change the amplitude of the received third party voice signals. Once the volume has been adjusted to the satisfaction of the user, mobile telephone 938 returns to ongoing call status 1114.

Mobile telephone 938 remains in ongoing call status 1114 until the call is terminated, or, in other words, ultra wideband wireless communication link 920 is voluntarily broken. The user may terminate the call by depressing button 910 with a long press 1110. By depressing button 910, remote control device 918 transmits a control signal, such as an AT command. Mobile telephone 938 then breaks the ultra wideband wireless communication link 940 and the wireless communication link 920 and returns to idle status 1106.

If ultra wideband wireless communication link 920 is undesirably broken 330, for example because the distance between remote control device 918 and mobile telephone 938 becomes too great, ultra wideband wireless communication link 940 will remain connected for an additional predetermined time period (state 331), for example, thirty seconds, so that the user can continue the telephone call through mobile telephone 938 instead of remote control device 918. The voice channels are given back to the mobile telephone 938 and a message may be shown on the mobile telephone's display (not shown). The user may confirm 1120 that he or she wishes to continue the call by activating one or more keys on the mobile telephone's keypad (not shown). If the user fails to intervene within the timeout period, a timeout will occur 1136, the ultra wideband wireless communication link 940 will be broken and the mobile telephone 938 returns to idle mode 304.

In another aspect of the invention, if the remote control device becomes reconnected 1120 during the predetermined period of time, the timer function within the mobile telephone 938 may be discontinued, and the voice channels again routed to the remote control device via ultra wideband wireless communication link 920.

To respond to an event, such as receiving an incoming call at remote control device 918 from mobile telephone 938, the user can either give a voice command or depress button 910 with a short press 1116. In the case that mobile telephone 938 is in voice control status 1118 because voice control circuitry 932 is activated at the time the incoming call is incoming, the user may give a voice command to accept 1116 or reject 1130 the call. The processing of this voice command is similar to that described above with respect to other voice commands. If the call is accepted, mobile telephone 938 is placed into ongoing call status 1114. If the call is rejected, mobile telephone 938 returns to idle status 1106. Mobile telephone 938 then transmits to remote control device 918 an “OK” signal indicating that communication between remote control device 918 and mobile telephone 938 can proceed.

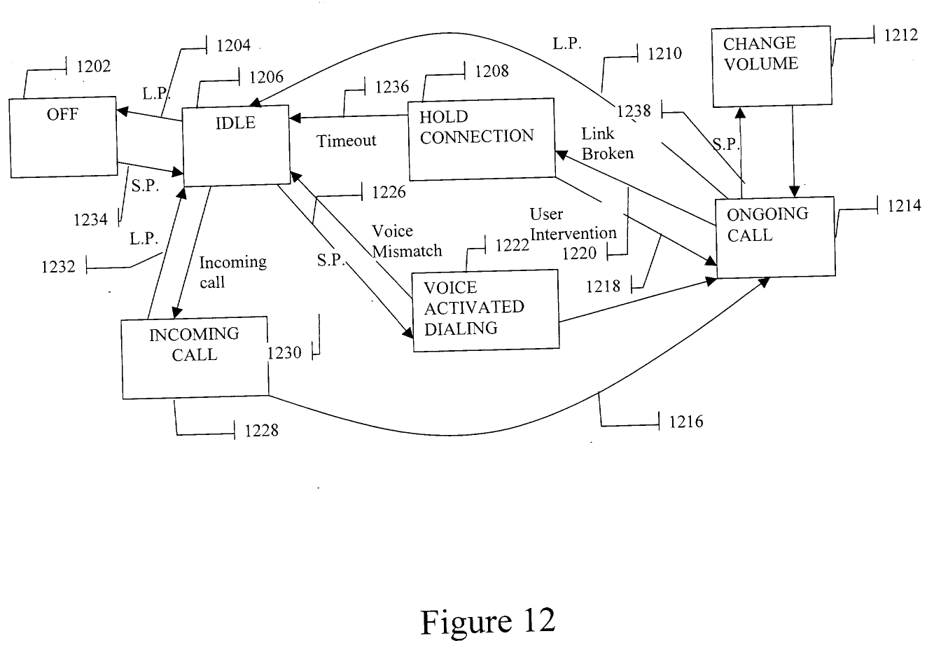

Alternatively, as shown in FIG. 12, if the mobile telephone 938 is not in voice control status 1118 because voice control circuitry 932 is not activated, the system can be configured such that a short press 1216 of button 910 accepts the incoming call. Upon depressing button 910, remote control device 918 transmits a control signal, such as AT command ATA, to mobile telephone 938 to accept the incoming call and to place mobile telephone 938 into ongoing call status 1114.

If mobile telephone 938 indicates to remote control device 918 that an event has occurred, such as an incoming call has been received, and the user does not desire to accept the call, the user can depress button 910 with a long press 322. Upon depressing button 910, remote control device 918 transmits a control signal to mobile telephone 938 indicating that the call is not accepted by remote control device 918. Mobile telephone 938 then returns to idle status 1106. Mobile telephone 938 transmits to remote control device 918 an “OK” signal indicating that communication between remote control device 918 and mobile telephone 938 can proceed.

To determine information about key presses at mobile telephone 938, remote control device 918 transmits a control signal, such as AT command AT+CKEV=3,2 to mobile telephone 938. Mobile telephone 938 receives the control signal. If a key on mobile telephone 938 is pressed, mobile telephone 938 transmits a control signal, such as AT command +CKEV, to remote control device 918. Mobile telephone 938 then transmits to remote control device 918 an “OK” signal indicating that communication between remote control device 918 and mobile telephone 938 can proceed.

The user may terminate ultra wideband wireless communication link 920. If mobile telephone 938 is in idle status 1106, the user may terminate ultra wideband wireless communication link 920 and ultra wideband wireless communication link 940 by depressing button 910 with a long keypress 1104. Upon depressing button 910, remote control device 918 transmits a control signal, such as AT command AT*ECBP.backslash.r, to mobile telephone 938 to close wireless communication link 920. Mobile telephone 938 receives this control signal and terminates ultra wideband wireless communication link 920 and ultra wideband wireless communication link 940.

In the event mobile telephone 938 transmits a telephone status indicating that a call over ultra wideband wireless communication link 940 has ended, remote control device 918 transmits a control signal, such as AT command AT*EHNG to mobile telephone 938 to close wireless communication link 920. Mobile telephone 938 receives this control signal and terminates ultra wideband wireless communication link 920.

In the event mobile telephone 938 transmits information indicating that a button, such as the “#” button, has been depressed, remote control device 918 transmits a control signal, such as AT command AT*EHND to mobile telephone 938 for handover. In this case, ultra wideband wireless communication link 920 is closed and ultra wideband wireless communication link 940 remains connected and continues in mobile telephone 938. Mobile telephone 938 receives this control signal, terminates ultra wideband wireless communication link 920, and continues receiving voice and data signals over ultra wideband wireless communication link 940. A new ultra wideband wireless communication link 920 can be established by remote control device 918 as described above.

Transition-causing signals illustrated in the above state diagrams can be implemented using any suitable communication protocol. For example, transitions in the above state diagram can be responsive to a series of AT commands as discussed above. However, such AT commands may differ depending upon the particular mobile telephone and the particular remote control device being utilized.

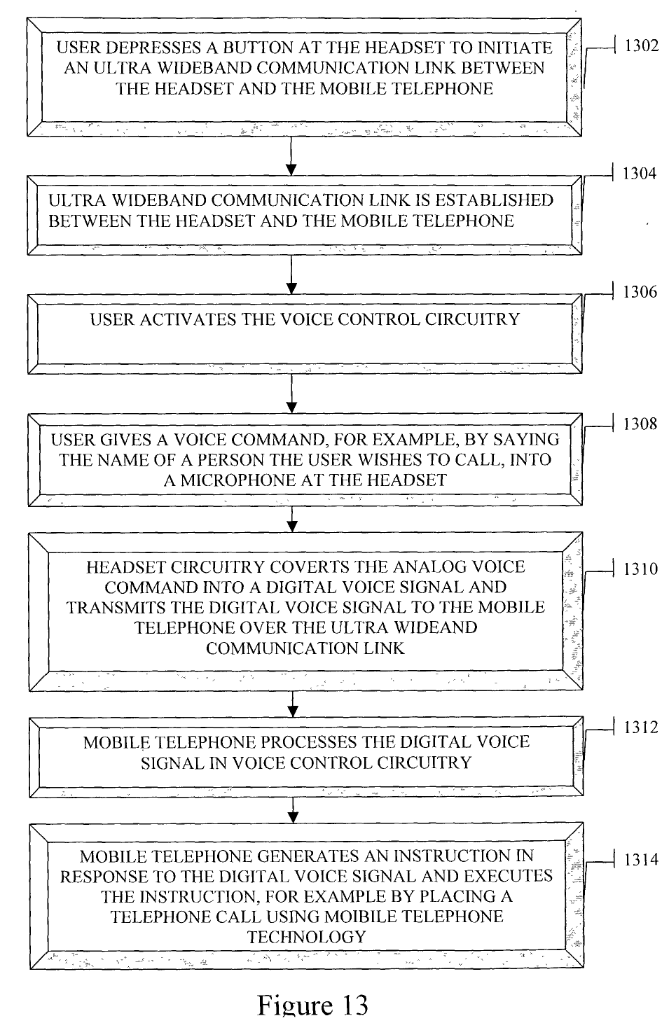

FIG. 13 shows a flow chart describing an outgoing call being placed from remote control device 918 according to one of a number of embodiments of the invention. This embodiment shall be described with reference to remote control device 918 being a headset and electronic device 104 being a mobile telephone. To place an outgoing call, a user depresses a button, or performs some other suitable input maneuver, located on the headset. (Step 1302). The depression of the button causes the headset to send one or more first control signals or other data to the mobile telephone and the mobile telephone to send one or more second control signals or other data to the headset in response After this exchange of signals and data, the ultra wideband wireless communication link between the headset and the mobile telephone is established. (Step 1304). The user then depresses the button again with a short press to activate the voice control circuitry, if the voice control circuitry is not already activated. (Step 1306). The depression of the button causes the headset to send a control signal to the mobile telephone to activate the voice control circuitry and the mobile telephone acknowledges the activation in a signal to the headset. The user then gives a voice command or signal, for example, by saying the name of the person the user wishes to call into a microphone of the headset. (Step 1308). Circuitry in the headset, such as an analog-to-digital converter, converts this analog voice signal into a digital voice signal and transmits the digital voice signal to the mobile telephone. (Step 1310). The mobile telephone processes the voice signal in voice control circuitry. (Step 1312). If the voice signal is recognized by the voice control circuitry, by comparing the voice signal with stored voice signals, the circuitry generates an instruction corresponding to the voice signal. The mobile telephone then executes the instruction by placing the telephone call according to known mobile telephone technology. (Step 1314). If the voice signal is not recognized by the voice control circuitry after comparing the voice signal with stored voice signals, the circuitry does not generate an instruction.

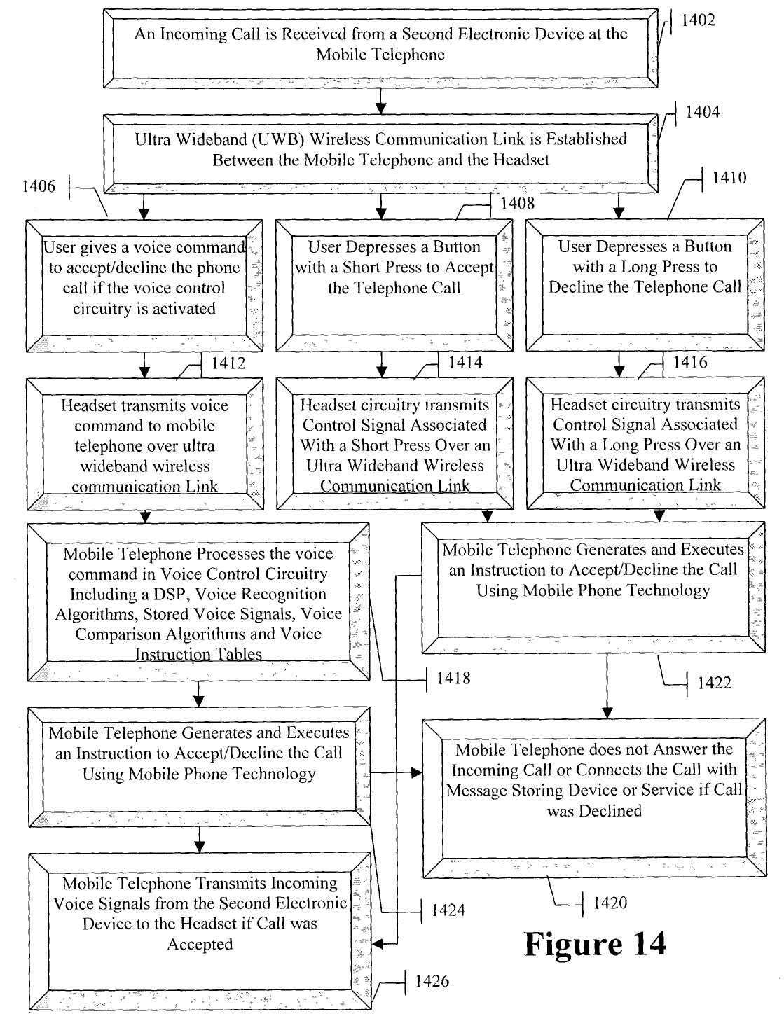

FIG. 14 shows a flow chart describing an incoming call being sent to remote control device 918 according to an alternative embodiment of the present invention. This embodiment shall also be described with reference to remote control device 918 being a headset and electronic device 104 being a mobile telephone. An incoming call is received from a second electronic device at the mobile telephone using known mobile telephone technology. (Step 1402). The mobile telephone sends one or more first control signals or other data to the headset to establish an ultra wideband wireless communication link (the use of ultra wideband is elaborated on above and in the patents and patent applications incorporated herein by reference). The headset sends one or more second control signals or other data to the mobile telephone in response. After this exchange of signals and data, the wireless communication link between the headset and the mobile telephone is established. (Step 1404). The mobile telephone sends a signal to the headset informing the user that a call is incoming. The user can choose to accept or decline receiving the call.

If voice control circuitry is activated in the mobile telephone, the user can give a voice command or signal into a microphone of the headset to accept or decline receiving the call. (Step 1406). In this case, the process is similar to that described above with respect to FIG. 13. Circuitry in the headset converts the voice signal from an analog signal to a digital voice signal. The headset transmits the digital voice signal to the mobile telephone over the ultra wideband wireless communication link. (Step 1412). The mobile telephone processes the voice signal in voice control circuitry. (Step 1418). If the voice signal is recognized by the voice control circuitry, by comparing the voice signal with stored voice signals, the circuitry generates an instruction corresponding to the voice signal.

The mobile telephone then executes the instruction by accepting or declining the telephone call. (Step 1424). If the mobile telephone is instructed to accept the call, the mobile telephone then transmits incoming voice signals from the second electronic device to the headset. (Step 1426). If the mobile telephone is instructed to decline the call, the mobile telephone does not answer the incoming call. (Step 1420). Alternatively, the mobile telephone can connect the call with a message storing device or service or perform some other suitable function. (Step 1420).

If the voice signal is not recognized by the voice control circuitry after comparing the voice signal with stored voice signals, the circuitry does not generate an instruction.

If voice control circuitry is not activated in the mobile telephone, the user can depress a button, or perform some other suitable input maneuver, on the headset to accept or decline the call. For example, the user can depress the button with a short press if the user wishes to accept the call. (Step 1408). The user can depress the button with a long press if the user wishes to decline the call. (Step 1410). The depression of the button causes the headset to send a control signal to the mobile telephone to accept or decline the call. (Steps 1414 and 1416). The mobile phone acknowledges the action in a return signal to the headset. The mobile telephone then accepts or declines the incoming call in accordance with mobile telephone technology. (Step 626). If the mobile telephone is instructed to accept the call, the mobile telephone transmits incoming voice signals from the second electronic device to the headset. (Step 614). If the mobile telephone is instructed to decline the call, the mobile telephone does not answer the incoming call. (Step 616) Alternatively, the mobile telephone can connect the call with a message storing device or service or perform some other suitable function. (Step 616).

In the above embodiments, the wireless communication link is established or opened when communication is desired and terminated or closed once communication is no longer desired. It is possible for the communication link between the remote control device and the electronic device to remain open, even when communication is no longer required. However, this may not be desirable because to maintain this communication link, the battery supplying power to the remote control device will be drained at a faster rate.

The invention has been described with reference to particular embodiments. However, it will be readily apparent to those skilled in the art that it is possible to embody the invention in specific forms other than those of the preferred embodiments described above. This may be done without departing from the spirit of the invention.

For example, the electronic device being controlled has been exemplified by a mobile telephone 938. However, this is not essential. Rather, the inventive techniques can be adapted to control any number of other devices, such as a computer (desktop or otherwise), or any of the other devices mentioned earlier.

Furthermore, the remote control device 918 has been illustrated by a headset or wrist device. However, this is not essential. Rather, the inventive techniques can be adapted for use in any other type of device having characteristics described herein with respect to the remote control device 918.

Still further, the remote control device 918 has been described as a device having a single button 910, with user commands distinguished from one another based on whether a long or short press has been performed. In other embodiments, further distinctions between commands can be made by further differentiating between other length presses, and/or between numbers of short and/or long presses.

What is claimed is:

1. A method of controlling an electronic device with a remote control device, the method comprising the steps of:
providing an impulse radio transmitter and impulse radio receiver and establishing an ultra wideband wireless communication link between said electronic device and said remote control device over which data signals and voice signals may be transmitted;
receiving a voice signal at the remote control device via said ultra wideband wireless communication link;
transmitting the voice signal from the remote control device to the electronic device via said ultra wideband wireless communication link;
receiving the voice signal at the electronic device;
generating an instruction responsive to the voice signal in the electronic device; and
executing the instruction in the electronic device;

2. The method of claim 1, further comprising:
transmitting at least one signal from the remote control device to the electronic device to elicit a response from the electronic device;
transmitting an operational status, via ultra wideband means, of the electronic device in response to one of the at least one signal;
storing the operational status in a memory unit in the remote control device,
updating the operational status of the electronic device; and
changing an operational status of the remote control device in response to the updating step.

3. The method of claim 1, wherein the establishing step is responsive to a user input at the remote control device, the establishing step comprising the steps of:
transmitting at least one first signal from the remote control device to the electronic device, via ultra wideband means, requesting that the ultra wideband wireless communication link be established; and
transmitting at least one second signal from the electronic device to the remote control device, via ultra wideband means, indicating that the ultra wideband wireless communication link is established.

4. The method of claim 1, wherein the establishing step is responsive to an event at the electronic device, the establishing step comprising the steps of:
transmitting at least one first signal from the electronic device to the remote control device, via ultra wideband means, requesting that the ultra wideband wireless communication link is established; and
transmitting at least one second signal from the remote control device to the electronic device, via ultra wideband means, indicating that the ultra wideband wireless communication link is established.

5. The method of claim 4, wherein the electronic device is a mobile telephone and the event is an incoming telephone call.

6. The method of claim 1, wherein the electronic device includes voice control circuitry, one of said at least one signal requests voice activated dialing, and the elicited response includes the electronic device utilizing the voice control circuitry.

7. The method of claim 1 wherein the at least one signal is an AT command.

8. The method of claim 1, further comprising the step of converting the voice signal from an analog signal to a digital signal prior to the transmitting step.

9. The method of claim 1, wherein the electronic device is a computer.

10. The method of claim 1, wherein the remote control device is a headset.

11. The method of claim 1, wherein the electronic device is a mobile telephone.

12. The method of claim 11, wherein:
the electronic device includes voice control circuitry;
one of the at least one signal requests voice activated dialing;
the elicited response includes the electronic device utilizing the voice control circuitry;
the voice signal indicates that a user desires to place a telephone call to an entity; and
the instruction instructs the electronic device to call the entity.

13. The method of claim 1, wherein the electronic device is a communication device engaged in an ongoing call, and further comprising the steps of:
in the electronic device, detecting that the ultra wideband wireless communication link has been broken;
in response to said detection, starting a timer; and
upon expiration of a predetermined timeout period, terminating the ongoing call.

14. The method of claim 13, further comprising the step of detecting user intervention within the predetermined timeout period, and in response thereto stopping the timer and maintaining the ongoing call.

15. An ultra wideband wireless, voice-activated remote control system for controlling an electronic device, the system comprising:
an electronic device;
a remote control device comprising a microphone, a speaker, an antenna, ultra wideband wireless link circuitry, and a user input device, wherein at least one voice signal is input into the microphone of the remote control device; and
an ultra wideband wireless communication link between the electronic device and the remote control device over which data signals and voice signals may be transmitted; wherein:
the voice signal is transmitted from the remote control device to the electronic device via said ultra wideband wireless communication link,
the voice signal is received at the electronic device,
the voice control circuitry generates an instruction responsive to the voice signal and the instruction is executed in the electronic device,
the remote control device transmits at least one signal to the electronic device to elicit a response from the electronic device,
the electronic device transmits an operational status of the electronic device in response to one of the at least one signal,
the remote control device stores the operational status in a memory unit in the remote control device,
the electronic device updates its operational status with the remote control device, and
the remote control device changes an operational status of the remote control device in response to the updated operational status of the electronic device.

16. The system of claim 15, wherein:
the ultra wideband wireless communication link is established in response to a signal from the user input device,
the remote control device transmits at least one first signal to the electronic device requesting that the ultra wideband wireless communication link be established, and
the electronic device transmits at least one second signal to the remote control device indicating that the ultra wideband wireless communication link is established.

17. The system of claim 15, wherein:
the ultra wideband wireless communication link is established in response to an event at the electronic device, the electronic device transmits at least one first signal to the remote control device requesting that the ultra wideband wireless communication link be established; and
the remote control device transmits at least one second signal to the electronic device indicating that the ultra wideband wireless communication link is established.

18. The system of claim 17, wherein the electronic device is a mobile telephone and the event is an incoming telephone call.

19. The system of claim 18, wherein:
the electronic device includes voice control circuitry,
one of the at least one signal requests voice activated dialing, and
the elicited response includes the electronic device utilizing the voice control circuitry.

20. The system of claim 18, wherein the at least one signal is an AT command.

21. The system of claim 15, further comprising an analog to digital converter for converting the voice signal from an analog signal to a digital signal prior to transmitting the voice signal to the electronic device.

22. The system of claim 21, wherein:
the remote control device transmits at least one signal to the electronic device to elicit a response from the electronic device,
one of the at least one signal requests voice activated dialing,
the elicited response includes the electronic device utilizing the voice control circuitry,
the voice signal indicates that a user desires to place a telephone call to an entity, and
the instruction instructs the electronic device to call the entity.

23. The system of claim 15, wherein the electronic device is a computer.

24. The system of claim 15, wherein the remote control device is a headset.

25. The system of claim 15, wherein the electronic device is a mobile telephone.

26. The system of claim 15, wherein the electronic device is a communication device engaged in an ongoing call, and further comprising:
in the electronic device, logic configured to detect that the ultra wideband wireless communication link has been broken;
a timer;
logic configured to start the timer in response to said detection;
logic configured to terminate the ongoing call in response to expiration of a predetermined timeout period.

27. The system of claim 26, further comprising:
logic configured to detect user intervention within the predetermined timeout period; and
logic configured to stop the timer and maintain the ongoing call in response to said detected user intervention.
